(19) United States
(12) Patent Application Publication
(10) Pub. No.: US 2025/0304105 A1
(43) Pub. Date: Oct. 2, 2025

(54) VEHICLE CONTROL DEVICE, CONTROL METHOD, AND COMPUTER READABLE MEDIUM STORING CONTROL PROGRAM

(71) Applicant: HONDA MOTOR CO., LTD., Tokyo (JP)

(72) Inventors: Takahiro FUJITA, Tokyo (JP); Yuki KIZUMI, Tokyo (JP); Ryo USHIKI, Tokyo (JP)

(73) Assignee: HONDA MOTOR CO., LTD., Tokyo (JP)

(21) Appl. No.: 19/064,735

(22) Filed: Feb. 27, 2025

(30) Foreign Application Priority Data
Mar. 28, 2024 (JP) 2024-053771

(51) Int. Cl. B60W 60/00; G01C 21/30; G06V 20/56

(52) U.S. Cl. CPC B60W 60/001; G01C 21/30; G06V 20/588

(57) ABSTRACT

A vehicle control device includes: a recognition unit; a trajectory generation unit; and a travel control unit, and in a case where the intersection is a four-way intersection connecting first to fourth roads as defined herein, and the vehicle is to travel from the first road to the third road, the trajectory generation unit identifies: a first reference point that is a contact point between the first road and the second road; and a second reference point that is a contact point between the third road and the fourth road or an intersection center that is a center of the intersection, based on a recognition result of the recognition unit, derives a first boundary line that is a line segment passing through the first reference point and the second reference point or the intersection center, and generates the travel trajectory along the first boundary line.

### CROSS-REFERENCE TO RELATED APPLICATION

This application is based on and claims priority under 35 USC 119 from Japanese Patent Application No. 2024-053771 filed on Mar. 28, 2024.

### TECHNICAL FIELD

The present invention relates to a vehicle control device, a control method, and a computer readable medium storing a control program for controlling a vehicle.

### BACKGROUND ART

In recent years, active efforts have been made to provide access to a sustainable transportation system in consideration of vulnerable traffic participants. As one of these efforts, research and development on driving assistance techniques and autonomous driving techniques for vehicles such as automobiles have been made in order to further improve safety and convenience of traffic.

As an example of the driving assist technology, the following Patent Literature 1 discloses a technique of: acquiring intersection information that is information related to an intersection that a host vehicle is about to enter; based on the intersection information, acquiring data indicating a position and direction of each of a plurality of arrow markings in front of the intersection; calculating a distance in a lane width direction to each of the plurality of road arrow markings from a travel track of a vehicle traveling at the intersection; determining a destination of a travel track of the host vehicle based on a direction of a reference road arrow marking that is a road arrow marking whose distance is less than a first threshold; generating data indicating a duplicated travel track obtained by duplicating the travel track in a manner translated to a position of a road arrow marking that indicates the same direction as the destination of the travel track and is different from the reference road arrow marking; and estimating a shape of a traveling lane in the intersection based on the data indicating the duplicated travel track.

### PATENT LITERATURE

Patent Literature 1: JP2023-160381A

### SUMMARY OF INVENTION

However, the conventional art described above requires to prepare information on the intersection in advance, and thus makes it difficult to cause the vehicle to appropriately travel in the intersection with a simple configuration without requiring such information.

The present invention provides a vehicle control device, a control method, and a computer readable medium storing a control program that enable a vehicle to appropriately travel in an intersection with a simple configuration. This further improves safety of traffic and contributes to development of a sustainable transportation system.

An aspect of the present invention relates to a vehicle control device for controlling a vehicle, including:

a recognition unit configured to recognize a surrounding situation of the vehicle;

a trajectory generation unit configured to, if an intersection present in a traveling direction of the vehicle is recognized by the recognition unit, generate a travel trajectory from an entry position to an exit position of the vehicle at the intersection; and

a travel control unit configured to cause the vehicle to travel based on the travel trajectory generated by the trajectory generation unit, in which

if the intersection is a four-way intersection obtained by connecting a first road on which the vehicle currently travels, a second road present on one side in a vehicle width direction relative to the vehicle, a third road present on the other side in the vehicle width direction relative to the vehicle, and a fourth road present on a side of the intersection opposite to the first road, and the vehicle is to travel from the first road to the third road,

the trajectory generation unit
identifies a first reference point that is a contact point between the first road and the second road, and a second reference point that is a contact point between the third road and the fourth road or an intersection center that is a center of the intersection, based on a recognition result of the recognition unit,
derives a first boundary line that is a line segment passing through the first reference point and the second reference point or the intersection center, and
generates the travel trajectory along the first boundary line.

Another aspect of the present invention relates to a control method of a computer for controlling a vehicle performing processing including:

recognizing a surrounding situation of the vehicle;

if an intersection present in a traveling direction of the vehicle is recognized, generating a travel trajectory from an entry position to an exit position of the vehicle at the intersection; and

causing the vehicle to travel based on the travel trajectory, in which

the processing of generating the travel trajectory includes:

if the intersection is a four-way intersection obtained by connecting a first road on which the vehicle currently travels, a second road present on one side in a vehicle width direction relative to the vehicle, a third road present on the other side in the vehicle width direction relative to the vehicle, and a fourth road present on a side of the intersection opposite to the first road, and the vehicle is to travel from the first road to the third road,
identifying a first reference point that is a contact point between the first road and the second road, and a second reference point that is a contact point between the third road and the fourth road or an intersection center that is a center of the intersection, based on a recognition result of the surrounding situation,
deriving a first boundary line that is a line segment passing through the first reference point and the second reference point or the intersection center, and
generating the travel trajectory along the first boundary line.

Another aspect of the present invention relates to a computer readable medium storing a control program for causing a computer for controlling a vehicle to perform processing including:

recognizing a surrounding situation of the vehicle;

if an intersection present in a traveling direction of the vehicle is recognized, generating a travel trajectory from an entry position to an exit position of the vehicle at the intersection; and

causing the vehicle to travel based on the travel trajectory, in which

the processing of generating the travel trajectory includes:

if the intersection is a four-way intersection obtained by connecting a first road on which the vehicle currently travels, a second road present on one side in a vehicle width direction relative to the vehicle, a third road present on the other side in the vehicle width direction relative to the vehicle, and a fourth road present on a side of the intersection opposite to the first road, and the vehicle is to travel from the first road to the third road,
identifying a first reference point that is a contact point between the first road and the second road, and a second reference point that is a contact point between the third road and the fourth road or an intersection center that is a center of the intersection, based on a recognition result of the surrounding situation,
deriving a first boundary line that is a line segment passing through the first reference point and the second reference point or the intersection center, and
generating the travel trajectory along the first boundary line.

According to the present invention, it is possible to provide a vehicle control device, a control method, and a computer readable medium storing a control program that enable a vehicle to appropriately travel in an intersection with a simple configuration.

### BRIEF DESCRIPTION OF DRAWINGS

FIG. 1 is a block diagram illustrating a schematic configuration of a vehicle 1 including a control device 30 that is an embodiment of a vehicle control device of the present invention.

FIG. 2 is a diagram illustrating an example of a situation assumed in the present embodiment.

FIG. 3 is a diagram illustrating an example of a travel trajectory generated when the vehicle 1 is to turn right at an intersection CP.

FIG. 4 is a diagram illustrating an example of a travel trajectory generated when the vehicle 1 is to turn left at the intersection CP.

FIG. 5 is a diagram illustrating an example of a travel trajectory generated when the vehicle 1 is to travel straight through the intersection CP.

FIG. 6 is a diagram illustrating another example of the travel trajectory generated when the vehicle 1 is to travel straight through the intersection CP.

FIG. 7 is a flowchart (part 1) illustrating an example of a processing procedure by the control device 30.

FIG. 8 is a flowchart (part 2) illustrating the example of the processing procedure by the control device 30.

FIG. 9 is a flowchart (part 3) illustrating the example of the processing procedure by the control device 30.

FIG. 10 is a flowchart (part 4) illustrating the example of the processing procedure by the control device 30.

FIG. 11 is a flowchart (part 5) illustrating the example of the processing procedure by the control device 30.

FIG. 12 is a flowchart (part 6k) illustrating the example of the processing procedure by the control device 30.

FIG. 13 is a flowchart (part 7) illustrating the example of the processing procedure by the control device 30.

FIG. 14 is a flowchart (part 8) illustrating the example of the processing procedure by the control device 30.

FIG. 15 is a diagram illustrating a modification of vehicle control performed by the control device 30.

### DESCRIPTION OF EMBODIMENTS

Hereinafter, an embodiment of a vehicle control device, a control method, and a control program of the present invention will be described with reference to the drawings. The drawings are viewed in directions of reference signs. The following embodiment does not limit the present invention, and not all elements described in the following embodiment are essential to the present invention. Further, two or more elements described in the following embodiment may be freely combined without departing from the gist of the present invention. In the following description, the same or similar elements are denoted by the same or similar reference numerals, and a description thereof may be omitted or simplified.

In addition, in the present description and the like, for the sake of simplicity and clarity of explanation, front-rear (including front and back), left-right, and upper-lower directions are described according to directions viewed from a driver who is an occupant of a vehicle (vehicle 1 described later), and in the drawings, a front side of the vehicle is represented by Fr, a rear side is represented by Rr, a left side is represented by L, and a right side is represented by R.

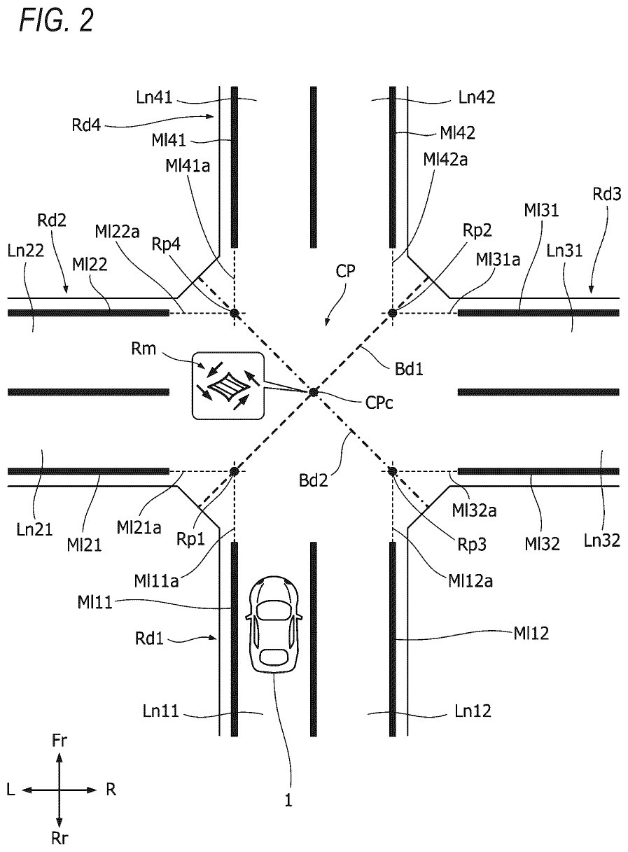

Further, the following embodiment will assume a left-hand traffic region such as Japan and describe an example in which one side in the vehicle width direction in the present invention is set to the left side and the other side in the vehicle width direction is set to the right side, but is not limited thereto. For example, if the present invention is applied to a right-hand traffic region such as the United States of America or the People's Republic of China, the one side in the vehicle width direction in the present invention may be set to the right side, and the other side in the vehicle width direction may be set to the left side. In this case, “turn right” and “turn left” in the following description may be interpreted as “turn left” and “turn right”, respectively, and FIGS. 2 to 6 and the like may be viewed with the left and right reversed as necessary.

### 1. Vehicle

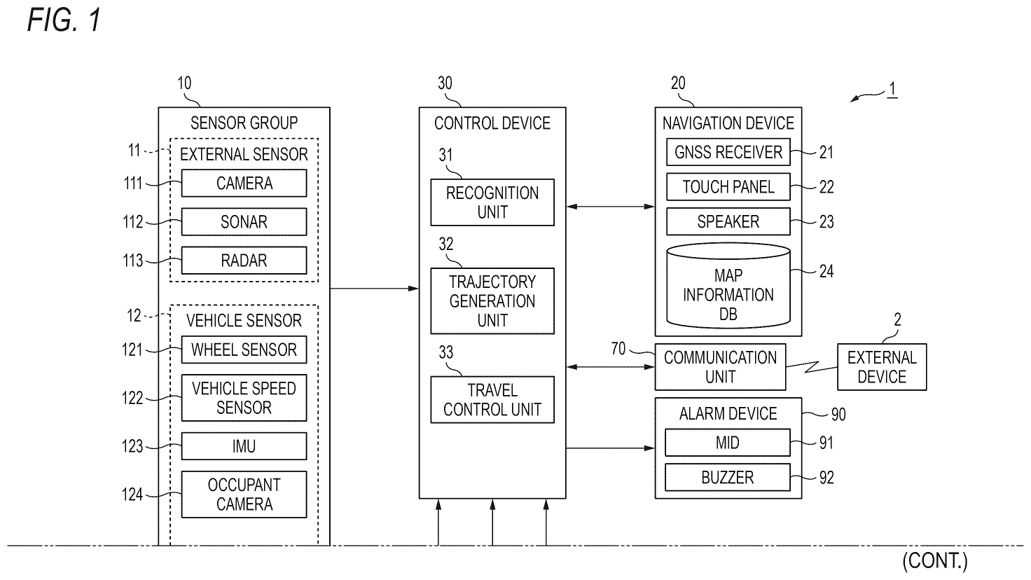

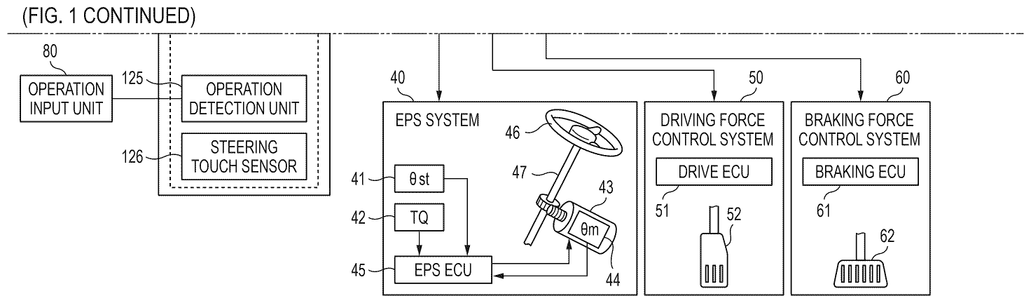

FIG. 1 is a block diagram illustrating a schematic configuration of a vehicle 1 including a control device 30 that is an embodiment of a vehicle control device of the present invention. A vehicle 1 according to the present embodiment illustrated in FIG. 1 is an automobile including a drive source (not illustrated), and wheels (not illustrated) including drive wheels driven by power of the drive source and steered wheels that are steerable. As an example, the vehicle 1 can be a four-wheeled automobile including a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or four wheels including the pair of left and right front wheels and the pair of left and right rear wheels. Either the front wheels or the rear wheels of the vehicle 1 may be steerable steered wheels, or the front wheels and the rear wheels may all be steerable steered wheels.

The vehicle 1 includes a sensor group 10, a navigation device 20, a control device 30 that is an example of the vehicle control device of the present invention, an electric power steering (EPS) system 40, a driving force control system 50, a braking force control system 60, a communication unit 70, an operation input unit 80, and an alarm device 90.

The sensor group 10 includes an external sensor 11 that acquires information on the surrounding of the vehicle 1 (hereinafter also referred to as “peripheral information”), and a vehicle sensor 12 that acquires information on the vehicle 1 (hereinafter also referred to as “vehicle information”). Information (in other words, detection values) acquired by each sensor in the sensor group 10 is output to the control device 30, and is used for control of the vehicle 1 (hereinafter, also referred to as “vehicle control”) performed by the control device 30.

The external sensor 11 includes, for example, a camera 111, a sonar 112, and a radar 113. The camera 111 is an imaging device that images the surroundings of the vehicle 1 including the front of the vehicle 1 and outputs image data of an obtained peripheral image to the control device 30. As the camera 111, for example, a digital camera using an imaging element such as a charge coupled device (CCD) or a complementary metal oxide semiconductor (CMOS) can be adopted.

The sonar 112 emits sound waves around the vehicle 1 (for example, a front, a rear, and lateral sides of the vehicle 1), and receives reflected sounds from an object present around the vehicle 1, thereby detecting a distance to the object, a direction of the object, and the like. The radar 113 emits radio waves to the periphery of the vehicle 1 including the front of the vehicle 1, and receives reflected waves from an object present in the periphery of the vehicle 1, thereby detecting a distance to the object, a direction of the object, and the like. As the radar 113, for example, a millimeter wave radar can be adopted.

The external sensor 11 may include light detection and ranging (LiDAR) instead of or in addition to the sonar 112 and the radar 113. In this case, the LiDAR emits laser light to the periphery of the vehicle 1 including the front of the vehicle 1, and receives reflected light from an object present around the vehicle 1, thereby detecting a distance to the object, an azimuth of the object, and the like.

The vehicle sensor 12 includes, for example, a wheel sensor 121, a vehicle speed sensor 122, an inertial measurement unit (IMU) 123, an occupant camera 124, an operation detection unit 125, and a steering touch sensor 126.

The wheel sensor 121 detects a rotation angle of one or more wheels among the wheels of the vehicle 1. As an example, the wheel sensor 121 detects a rotation angle of each of the left rear wheel and the right rear wheel. As the wheel sensor 121, for example, an angle sensor or a displacement sensor can be adopted.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a counter shaft (not illustrated) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. The vehicle sensor 12 may include, instead of the inertial measurement unit 123, an acceleration sensor that detects an acceleration of the vehicle 1 in a predetermined direction and a gyro sensor that detects an angular velocity of the vehicle 1 in a predetermined direction.

The occupant camera 124 is a digital camera that images the interior of the vehicle 1 and outputs image data of the obtained interior image to the control device 30. For example, the occupant camera 124 may be a so-called “driver monitor camera” that is capable of imaging the head of an occupant who sits on the driver's seat of the vehicle 1 (hereinafter, also referred to as a “driver”) from the front (in other words, imaging the face). Similarly to the camera 111, a digital camera using an imaging element such as a CCD or a CMOS can be employed as the occupant camera 124.

The operation detection unit 125 detects an operation performed by using the operation input unit 80 that is operable by the driver. In the present embodiment, the operation input unit 80 may include, for example, an operation button for receiving an operation to switch between on (in other words, operation) and off (in other words, non-operation) of predetermined driving assist control such as steering control by a travel control unit 33 described later. In this case, the operation detection unit 125 can detect an operation of turning on or off the predetermined driving assist control.

The steering touch sensor 126 detects whether a steering 46 of the vehicle 1 is gripped appropriately. For example, the steering touch sensor 126 is implemented by a capacitance sensor or the like. In this case, the capacitance sensor is provided at a portion touched by the driver when the steering 46 is gripped appropriately.

The navigation device 20 includes, for example, a global navigation satellite system (GNSS) receiver 21, a touch panel 22, and a speaker 23. The navigation device 20 includes a storage unit (not illustrated) implemented by a flash memory or the like. The storage unit of the navigation device 20 stores a map information database (DB) 24 as an example of map information and the like.

The map information database 24 includes road network information. The road network information is information representing roads based on a combination of nodes and links connecting the nodes (also referred to as “paths”). Each node in the road network information represents, for example, a feature point on a road such as an intersection, a corner, or a dead end. In the road network information, each node is set with, for example, information indicating a location corresponding to the node (for example, coordinates that enable the identification of one point on a map such as latitude and longitude). In addition, in the road network information, each link is set with information indicating nodes at both ends of the link, a road corresponding to the link, a link length, a lane number, a traveling direction, a road type, and the like.

The GNSS receiver 21 identifies a current position of the vehicle 1 (for example, a latitude and a longitude of a location where the vehicle 1 is located) based on a signals received from a GNSS satellite. For example, the navigation device 20 may acquire a detection result of the vehicle sensor 12 (for example, the wheel sensor 121 or the vehicle speed sensor 122) via the control device 30, and identify or complement the current position of the vehicle 1 by an inertial navigation system (INS) using a detection value of the vehicle sensor 12.

The touch panel 22 is implemented by combining a display device such as a liquid crystal display or an organic light emitting diode (OLED) with a pointing device (for example, touch pad). The speaker 23 is configured to output sound to an occupant (for example, a driver) of the vehicle 1.

For example, by referring to the map information database 24, the navigation device 20 searches for a route from the current position of the vehicle 1 to a destination set by the driver using the touch panel 22. Then, the navigation device 20 performs route guidance using the touch panel 22 and the speaker 23 based on the route searched for. The navigation device 20 may cause the touch panel 22 to perform a predetermined display according to an instruction from the control device 30. Further, the navigation device 20 may output, to the control device 30, information indicating the identified current position of the vehicle 1 or predetermined information (for example, information indicating an operation received via the touch panel 22).

In the present embodiment, the control device 30 is configured to refer to the map information database 24 (that is, map information) of the navigation device 20. However, the present invention is not limited thereto. Map information including road network information similar to that of the map information database 24 may be separately stored in the control device 30 or the like, and the control device 30 may refer to such map information.

The control device 30 is a computer that includes, for example, a processor configured to perform various calculations, a storage unit having a non-transitory storage medium (for example, a flash memory) for storing various types of information, and an input and output unit configured to control input and output of data between the inside and the outside of the control device 30 (none illustrated), and executes overall control of the vehicle 1. For example, the control device 30 is implemented by one electronic control unit (ECU) or by a plurality of ECUs working in cooperation with each other. Since specific examples of control executed by the control device 30 will be described later, the description thereof will be omitted here.

The EPS system 40 includes a steering angle sensor 41, a torque sensor 42, an EPS motor 43, a resolver 44, and an EPS ECU 45.

The steering angle sensor 41 detects a steering angle θst of the steering wheel 46 and outputs information indicating the detected steering angle θst to the EPS ECU 45. The torque sensor 42 detects a steering torque TQ, which is a torque applied to the steering wheel 46 of the vehicle 1, and outputs information indicating the detected steering torque TQ to the EPS ECU 45.

The EPS motor 43 assists the driver in operating the steering wheel 46 by applying, according to an instruction from the EPS ECU 45, a driving force or a reaction force to a steering column 47 connected to the steering wheel 46. The resolver 44 detects a rotation angle θm of the EPS motor 43 and outputs information indicating the detected rotation angle θm to the EPS ECU 45.

The EPS ECU 45 is a computer that includes, for example, a processor configured to perform various calculations, a storage unit having a non-transitory storage medium for storing various types of information, and an input and output unit configured to control input and output of data between the inside and the outside of the EPS ECU 45 (none illustrated), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like. The EPS ECU 45 may control the EPS system 40 according to an instruction from the control device 30.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering wheel 46 to the control device 30. In this case, the steering speed ω is obtained by, for example, differentiating the steering angle θst with respect to time.

The driving force control system 50 includes a drive ECU 51, and is configured to control a driving force of the vehicle 1. The drive ECU 51 is a computer that includes, for example, a processor configured to perform various calculations, a storage unit having a non-transitory storage medium for storing various types of information, and an input and output unit configured to control input and output of data between the inside and the outside of the drive ECU 51 (none illustrated), and controls the driving force control system 50. The drive ECU 51 is implemented by one or more ECUs. For example, based on an operation on an accelerator pedal 52 provided in the vehicle 1, the drive ECU 51 controls the power output from the drive source of the vehicle 1. The drive ECU 51 can also control the driving force control system 50 (for example, a drive source) according to an instruction from the control device 30.

The braking force control system 60 includes a braking ECU 61, and is configured to control a braking force of the vehicle 1. The braking ECU 61 is a computer that includes, for example, a processor configured to perform various calculations, a storage unit having a non-transitory storage medium for storing various types of information, and an input and output unit configured to control input and output of data between the inside and the outside of the braking ECU 61 (none illustrated), and controls the braking force control system 60. The braking ECU 61 is implemented by one or more ECUs. For example, the braking ECU 61 controls the braking force of the vehicle 1 by controlling a brake device (not illustrated) provided in the vehicle 1 based on an operation on a brake pedal 62 provided in the vehicle 1. Here, the brake device includes, for example, a brake caliper, a cylinder that transmits a hydraulic pressure to the brake caliper, and an electric motor that generates a hydraulic pressure in the cylinder. The braking ECU 61 controls the electric motor of the brake device such that a braking force corresponding to the operation on the brake pedal 62 is generated. The braking ECU 61 can also control the braking force control system 60 (for example, a brake device) according to an instruction from the control device 30.

The communication unit 70 is a communication interface that communicates with an external device 2 under control executed by the control device 30. That is, the control device 30 may communicate with the external device 2 via the communication unit 70. Examples of the external device 2 can include a terminal device (for example, a smartphone) of the driver and a server device managed by a manufacturer of the vehicle 1. For example, a mobile communication network such as a cellular line, WI-FI (registered trademark), or Bluetooth (registered trademark) can be adopted for communication between the vehicle 1 and the external device 2.

The alarm device 90 is a device that alarms the driver according to the control of the control device 30. The alarm device 90 includes, for example, a multi-information display (MID) 91 and a buzzer 92.

The MID 91 is implemented by a display device such as a liquid crystal display or an OLED, and is provided at a position that the driver can visually recognize (for example, in a meter panel of the vehicle 1). For example, the MID 91 displays a predetermined alarm image in accordance with an instruction from the control device 30. The MID 91 may be integrated with the touch panel 22 described above. That is, the “MID 91” in the following description may be interpreted as the “touch panel 22”.

The buzzer 92 is configured to output a predetermined alarm sound. For example, the buzzer 92 outputs a predetermined alarm sound in accordance with an instruction from the control device 30. The buzzer 92 may be integrated with the speaker 23 described above. That is, the “buzzer 92” in the following description may be interpreted as the “speaker 23”.

### 2. Control Device

Next, the control device 30 will be described in more details. First, for the sake of simplicity and clarity of explanation, the terms that may be used in the following description will be described.

FIG. 2 is a diagram illustrating an example of a situation assumed in the present embodiment. The present embodiment assumes that, for example, the vehicle 1 travels at an intersection of a four-way intersection as illustrated in FIG. 2.

### Travel Path Rd1

In FIG. 2, a travel path Rd1 is a road on which the vehicle 1 currently travels, and is a two-lane road including a lane Ln11 and a lane Ln12. The travel path Rd1 is an example of a first road in the present invention.

The lane Ln11 is a lane whose traveling direction is a direction from the lower side toward the upper side in FIG. 2, and can also be referred to as the “host lane” in which the vehicle 1 travels. A traveling lane boundary Ml11 is a traveling lane boundary that divides the lane Ln11 from the outside of the travel path Rd1, and is specifically a division line, a curb, or the like provided between the lane Ln11 and the outside on the left side of the travel path Rd1. An extension line Ml11a is an extension line of the traveling lane boundary Ml11, and is specifically a virtual line extending along the traveling lane boundary Ml11.

The lane Ln12 is a lane whose traveling direction is a direction from the upper side toward the lower side in FIG. 2, and can also be referred to as the “oncoming lane” whose traveling direction is opposite to the host lane. A traveling lane boundary Ml12 is a traveling lane boundary that divides the lane Ln12 from the outside of the travel path Rd1, and is specifically a division line, a curb, or the like provided between the lane Ln12 and the outside on the right side of the travel path Rd1. An extension line Ml12a is an extension line of the traveling lane boundary Ml12, and is specifically a virtual line extending along the traveling lane boundary Ml12.

### Left Road Rd2

The left road Rd2 is a road present on the left side (that is, one side in the vehicle width direction) relative to the vehicle 1, and is a two-lane road including a lane Ln21 and a lane Ln22. The left road Rd2 is an example of a second road in the present invention.

The lane Ln21 is a lane whose traveling direction is a direction from the right toward the left in FIG. 2. A traveling lane boundary Ml21 is a traveling lane boundary that divides the lane Ln21 from the outside of the left road Rd2, and is specifically a division line, a curb, or the like provided between the lane Ln21 and the outside on the front side of the left road Rd2. An extension line Ml21a is an extension line of the traveling lane boundary Ml21, specifically, a virtual line extending along the traveling lane boundary Ml21.

The lane Ln22 is a lane whose traveling direction is a direction from the left toward the right in FIG. 2. A traveling lane boundary Ml22 is a traveling lane boundary that divides the lane Ln22 from the outside of the left road Rd2, and is specifically a division line, a curb, or the like provided between the lane Ln22 and the outside on the back side of the left road Rd2. An extension line Ml22a is an extension line of the traveling lane boundary Ml22, and is specifically a virtual line extending along the traveling lane boundary Ml22.

### Right Road Rd3

The right road Rd3 is a road present on the right side (that is, the other side in the vehicle width direction) relative to the vehicle 1, and is a two-lane road including a lane Ln31 and a lane Ln32. The right road Rd3 is an example of a third road in the present invention.

The lane Ln31 is a lane whose traveling direction is a direction from the left toward the right in FIG. 2. The traveling lane boundary Ml31 is a traveling lane boundary that divides the lane Ln31 from the outside of the right road Rd3, and is specifically a division line, a curb, or the like provided between the lane Ln31 and the outside on the back side of the right road Rd3. An extension line Ml31a is an extension line of the traveling lane boundary Ml31, and is specifically a virtual line extending along the traveling lane boundary Ml31.

The lane Ln32 is a lane whose traveling direction is a direction from the right toward the left in FIG. 2. The traveling lane boundary Ml32 is a traveling lane boundary that divides the lane Ln32 from the outside of the right road Rd3, and is specifically a division line, a curb, or the like provided between the lane Ln32 and the outside on the front side of the right road Rd3. An extension line Ml32a is an extension line of the traveling lane boundary Ml32, and is specifically a virtual line extending along the traveling lane boundary Ml32.

### Opposite Road Rd4

The opposite road Rd4 is a road present on the side of an intersection CP (described later) opposite to the travel path Rd1, and is a two-lane road including a lane Ln41 and a lane Ln42. The right road Rd3 is an example of a third road in the present invention.

The lane Ln41 is a lane whose traveling direction is a direction from the lower side toward the upper side in FIG. 2. The traveling lane boundary Ml41 is a traveling lane boundary that divides the lane Ln41 from the outside of the opposite road Rd4, and is specifically a division line, a curb, or the like provided between the lane Ln41 and the outside on the left side of the opposite road Rd4. An extension line Ml41a is an extension line of the traveling lane boundary Ml41, and is specifically a virtual line extending along the traveling lane boundary Ml41.

The lane Ln42 is a lane whose traveling direction is a direction from the upper side toward the lower side in FIG. 2. The traveling lane boundary Ml42 is a traveling lane boundary that divides the lane Ln42 from the outside of the opposite road Rd4, and is specifically a division line, a curb, or the like provided between the lane Ln42 and the outside on the right side of the opposite road Rd4. An extension line Ml42a is an extension line of the traveling lane boundary Ml42, and is specifically a virtual line extending along the traveling lane boundary Ml42.

### Intersection CP

The intersection CP is a four-way intersection obtained by connecting the travel path Rd1, the left road Rd2, the right road Rd3, and the opposite road Rd4. An intersection center CPc is the center of the intersection CP under the control of the control device 30. That is, the intersection center CPc may be different from the actual center of the intersection CP.

For example, the intersection CP may be provided with a right-left-turn method road marking Rm at the actual center thereof. Here, the right-left-turn method road marking Rm is a road marking that designates a portion for the vehicle 1 to pass through when turning right or left at the intersection CP. The intersection center CPc may be a location provided with such a right-left-turn method road marking Rm, and may be specifically the center of the right-left-turn method road marking Rm. Further, the intersection center CPc may be an intersection point of a first boundary line Bd1 and a second boundary line Bd2 described later.

### First Reference Point Rp1

A first reference point Rp1 is a contact point between the travel path Rd1 and the left road Rd2 under the control of the control device 30. For example, the first reference point Rp1 may be an intersection of the extension line Ml11a of the traveling lane boundary Ml11 on the left side of the travel path Rd1 and the extension line Ml21a of the traveling lane boundary Ml21 on the front side of the left road Rd2.

### Second Reference Point Rp2

A second reference point Rp2 is a contact point between the right road Rd3 and the opposite road Rd4 under the control of the control device 30. For example, the second reference point Rp2 may be an intersection of the extension line Ml31a of the traveling lane boundary Ml31 on the back side of the right road Rd3 and the extension line Ml42a of the traveling lane boundary Ml42 on the right side of the opposite road Rd4.

### Third Reference Point Rp3

A third reference point Rp3 is a contact point between the travel path Rd1 and the right road Rd3 under the control of the control device 30. For example, the third reference point Rp3 may be an intersection of the extension line Ml12a of the traveling lane boundary Ml12 on the right side of the travel path Rd1 and the extension line Ml32a of the traveling lane boundary Ml32 on the front side of the right road Rd3.

### Fourth Reference Point Rp4

A fourth reference point Rp4 is a contact point between the left road Rd2 and the opposite road Rd4 under the control of the control device 30. For example, the fourth reference point Rp4 may be an intersection of the extension line Ml22a of the traveling lane boundary Ml22 on the back side of the left road Rd2 and the extension line Ml41a of the traveling lane boundary Ml41 on the left side of the opposite road Rd4.

### First Boundary Line Bd1

The first boundary line Bd1 is a virtual line of a line segment passing through the first reference point Rp1 and the second reference point Rp2 or the intersection center CPc. That is, the first boundary line Bd1 may be a virtual line of a line segment passing through the first reference point Rp1 and the second reference point Rp2, or may be a virtual line of a line segment passing through the first reference point Rp1 and the intersection CP.

### Second Boundary Line Bd2

The second boundary line Bd2 is a virtual line of a line segment passing through the third reference point Rp3 and the fourth reference point Rp4 or the intersection center CPc. That is, the second boundary line Bd2 may be a virtual line of a line segment passing through the third reference point Rp3 and the fourth reference point Rp4, or may be a virtual line of a line segment passing through the third reference point Rp3 and the intersection center CPc.

Example of Processing Implemented with Functional Units of Control Device

The control device 30 includes, for example, a recognition unit 31, a trajectory generation unit 32, and a travel control unit 33 as functional units implemented by the processor executing a program stored in the storage unit of the control device 30.

The recognition unit 31 recognizes a surrounding situation of the vehicle 1. For example, the recognition unit 31 performs sensor fusion processing on detection results obtained by some or all of the camera 111, the sonar 112, and the radar 113 in the external sensor 11, and recognizes the surrounding situation of the vehicle 1 based on a processing result.

The recognition unit 31 recognizes a position, a type, a speed, an acceleration, and the like of an object present around the vehicle 1 as the surrounding situation of the vehicle 1. At this time, the recognition unit 31 recognizes the position of the object as a position on absolute coordinates in which a representative point (for example, a center of gravity and a center of a drive shaft) of the vehicle 1 is set as an origin. Accordingly, a relative position between the vehicle 1 and the object present around can be recognized. In the absolute coordinate system, the position of the object may be represented using a representative point such as a center of gravity or a corner of the object, or may be represented as an area.

Examples of objects that can be recognized by the recognition unit 31 include traffic participants such as other vehicles and pedestrians, traveling lane boundaries that define lanes such as division lines, curbs and separation zones, road structures such as guard rails and road shoulders, and road markings (for example, a right-left-turn method road marking Rm as illustrated in FIG. 2) or road signs. The first recognition unit 31 may recognize, for example, other road events such as a traffic light, a stop line, a crosswalk, a branch, a junction, an interchange, and a tollbooth of a toll road.

According to such a recognition unit 31, for example, it is possible to recognize the traveling lane boundaries such as the traveling lane boundary Ml11 of the travel path Rd1 and the traveling lane boundary Ml21 of the left road Rd2 illustrated in FIG. 2, and road markings such as the right-left-turn method road marking Rm. Further, the recognition unit 31 can recognize the shape of the host lane on which the vehicle 1 travels, the intersection CP present in the traveling direction of the vehicle 1, and the like based on the recognition result of the traveling lane boundary. For example, the recognition unit 31 may recognize the intersection CP present in the traveling direction of the vehicle 1 based on the current position of the vehicle 1 identified by the navigation device 20 (for example, the GNSS receiver 21) and map information such as the map information database 24.

If the intersection CP present in the traveling direction of the vehicle 1 is recognized by the recognition unit 31, the trajectory generation unit 32 generates a travel trajectory from the entry position of the vehicle 1 at the intersection CP (hereinafter, also referred to as an “entry position PA”) to the exit position of the vehicle 1 at the intersection CP (hereinafter, also referred to as an “exit position PE”). Here, the travel trajectory is a trajectory for the vehicle 1 to travel, and can also be referred to as a “target traveling line”.

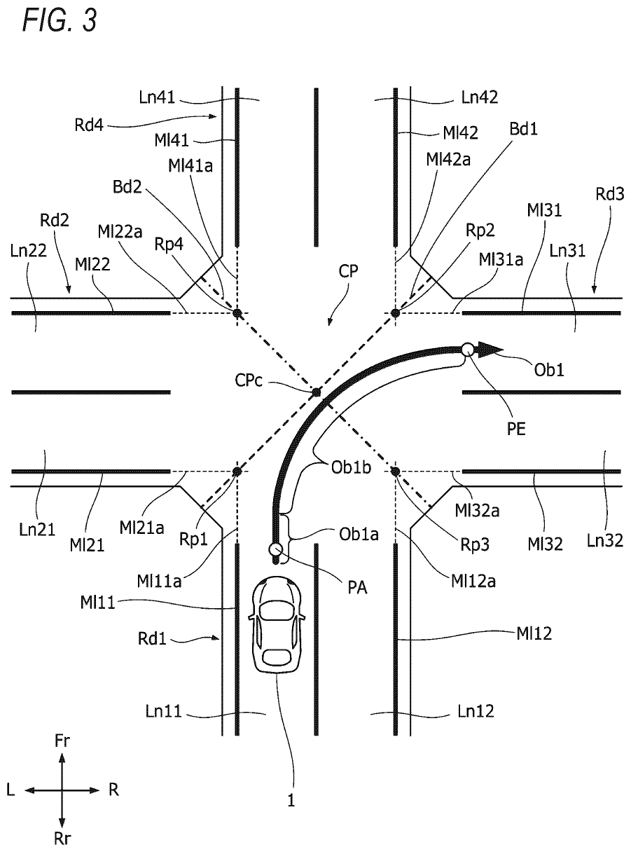

Although details will be described later, if the vehicle 1 is to travel from the travel path Rd1 to the right road Rd3 at the intersection CP present in the traveling direction (in other words, if the vehicle 1 is to turn right at the intersection CP), the trajectory generation unit 32 identifies: the first reference point Rp1 which is the contact point between the travel path Rd1 and the left road Rd2; and the second reference point Rp2 which is the contact point between the right road Rd3 and the opposite road Rd4, or the intersection center CPc which is the center of the intersection CP, based on the recognition result of the recognition unit 31. Then, the trajectory generation unit 32 derives the first boundary line Bd1, which is a line segment passing through the identified first reference point Rp1 and the second reference point Rp2 or the intersection center CPc, and generates a travel trajectory along the derived first boundary line Bd1 (for example, see a travel trajectory Ob1 in FIG. 3).

The trajectory generation unit 32 can geometrically identify the reference points illustrated in FIG. 2 such as the first reference point Rp1 and the second reference point Rp2 based on the recognition result of the traveling lane boundaries by the recognition unit 31. As an example, as described above, the first reference point Rp1 may be identified as the intersection of the extension line Ml11a of the traveling lane boundary Ml11 of the travel path Rd1 and the extension line Ml21a of the traveling lane boundary Ml21 of the left road Rd2. The trajectory generation unit 32 can also identify the intersection center CPc based on the recognition result of the right-left-turn method road marking Rm by the recognition unit 31 or the identified reference point. Then, the trajectory generation unit 32 can geometrically derive the first boundary line Bd1 based on the identified reference point and the intersection center CPc.

The road (that is, the direction) the vehicle 1 is about to travel at the intersection CP can be determined based on, for example, route guidance performed by the navigation device 20 or the lighting state of a direction indicator (not illustrated) included in the vehicle 1. If the vehicle 1 is an autonomous vehicle that travels autonomously, the road the vehicle 1 is about to travel at the intersection CP may be determined based on a travel plan generated based on a route to a destination.

Incidentally, for example, if the intersection CP is present in the traveling direction of the vehicle 1 but the vehicle 1 has not entered the intersection CP (in other words, if the vehicle 1 is still away from the intersection CP), the recognition unit 31 may not be capable of recognizing the traveling lane boundary Ml31 on the back side of the right road Rd3, the traveling lane boundary Ml42 on the right side of the opposite road Rd4, or the like. In such a case, the trajectory generation unit 32 cannot identify the second reference point Rp2, which is the contact point between the right road Rd3 and the opposite road Rd4, based on the recognition result of the recognition unit 31.

Therefore, if the second reference point Rp2 can be identified based on the recognition result of the recognition unit 31, the trajectory generation unit 32 may derive a line segment passing through the first reference point Rp1 and the second reference point Rp2 as the first boundary line Bd1 as described above. On the other hand, if the second reference point Rp2 cannot be identified based on the recognition result of the recognition unit 31, the trajectory generation unit 32 may set the intersection center CPc to a location indicated by a node corresponding to the intersection CP in the map information such as the map information database 24, and derive a line segment passing through the first reference point Rp1 and the intersection center CPc as the first boundary line Bd1. If the intersection center CPc is set to the location indicated by the node corresponding to the intersection CP, the trajectory generation unit 32 may set the intersection center CPc based on, for example, the positional relationship between the current position of the vehicle 1 identified by the navigation device 20 (for example, the GNSS receiver 21) and the location indicated by the node corresponding to the intersection CP.

Further, for example, when the vehicle 1 enters the intersection CP, the recognition unit 31 may be capable of recognizing the right-left-turn method road marking Rm provided at the intersection CP. As described above, if the right-left-turn method road marking Rm is recognized by the recognition unit 31, the trajectory generation unit 32 may set the intersection center CPc to a location provided with the right-left-turn method road marking Rm and generate the travel trajectory using the intersection center CPc. As a result, a location that substantially coincides with the actual center of the intersection CP can be set as the intersection center CPc, so that it is possible to generate an appropriate travel trajectory.

In the present embodiment, if the vehicle 1 is to turn right at the intersection CP, when the right-left-turn method road marking Rm is recognized by the recognition unit 31, the trajectory generation unit 32 sets the intersection center CPc to a location provided with the right-left-turn method road marking Rm, and derives the first boundary line Bd1 passing through the first reference point Rp1 and the intersection center CPc. Alternatively, if the right-left-turn method road marking Rm is not recognized by the recognition unit 31 but the second reference point Rp2 is identified based on the recognition result of the recognition unit 31, the trajectory generation unit 32 derives the first boundary line Bd1 passing through the first reference point Rp1 and the identified second reference point Rp2. If the second reference point Rp2 is not identified based on the recognition result of the recognition unit 31, the trajectory generation unit 32 sets the intersection center CPc to the location indicated by the node corresponding to the intersection CP in the map information such as the map information database 24, and derives the first boundary line Bd1 passing through the first reference point Rp1 and the intersection center CPc.

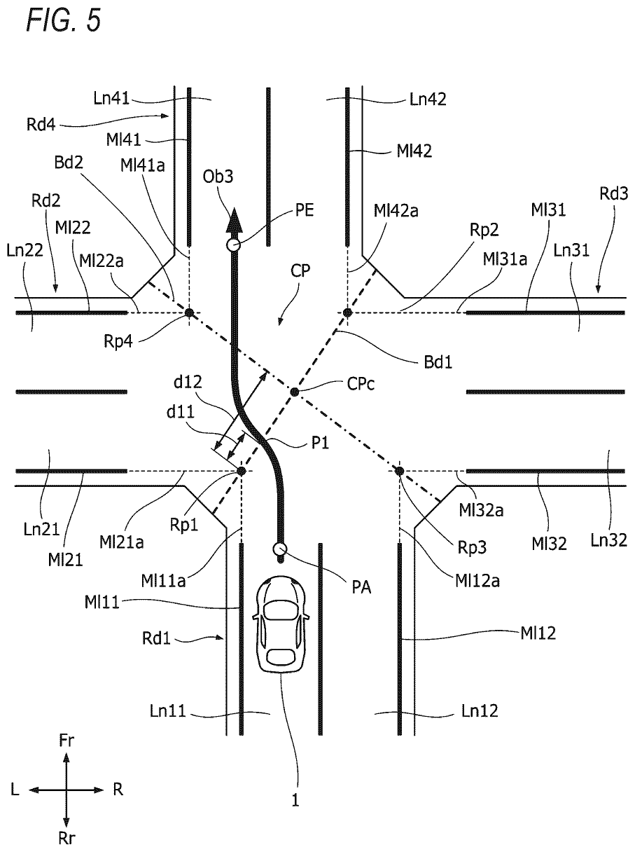

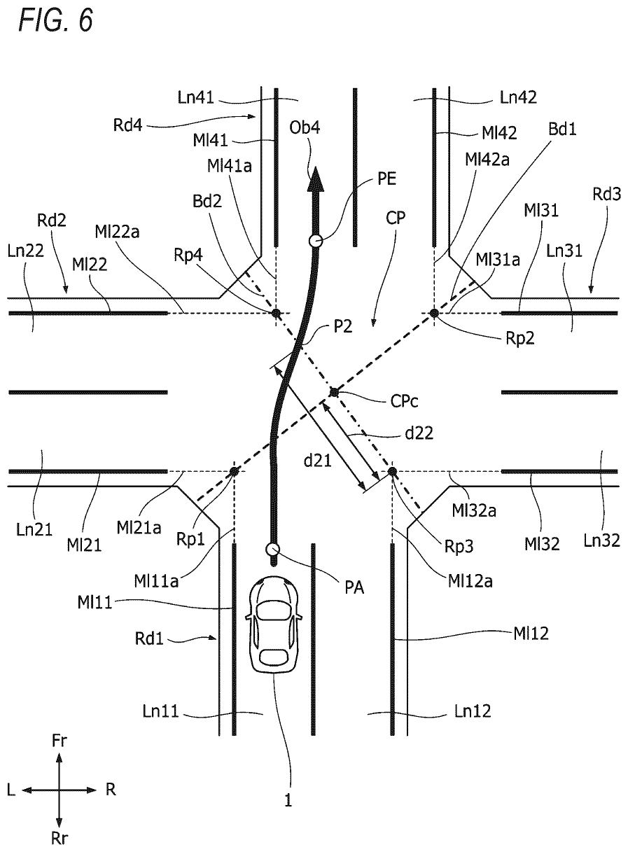

Incidentally, the vehicle 1 may travel from the travel path Rd1 to the opposite road Rd4 at the intersection CP present in the traveling direction (in other words, the vehicle 1 may travel straight through the intersection CP) depending on, for example, the route to the destination. As described above, if the vehicle 1 is to travel from the travel path Rd1 to the opposite road Rd4 at the intersection CP present in the traveling direction, the trajectory generation unit 32 may generate a travel trajectory from the entry position PA toward the exit position PE without interfering with the intersection center CPc (for example, see a travel trajectory Ob3 in FIG. 5 and a travel trajectory Ob4 in FIG. 6).

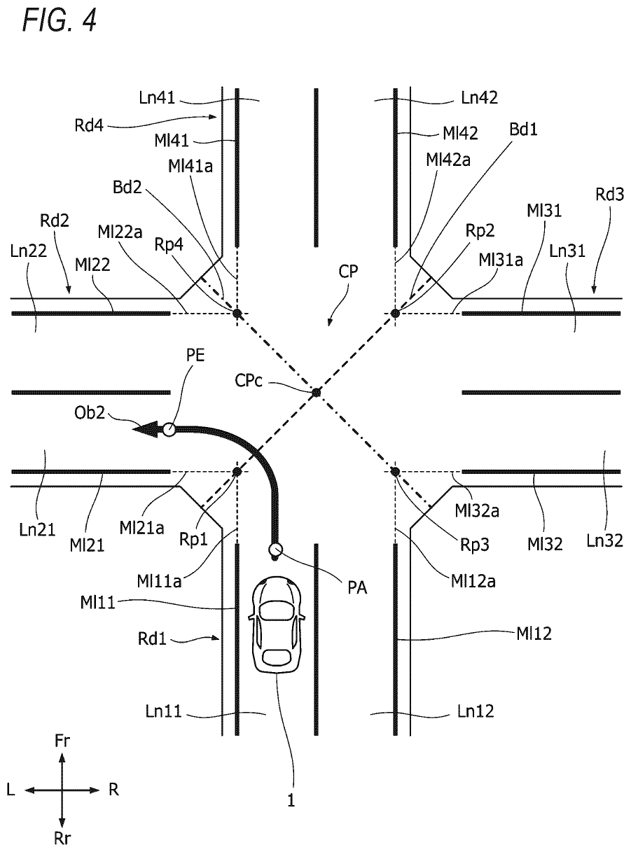

Similarly, the vehicle 1 may travel from the travel path Rd1 to the left road Rd2 at the intersection CP present in the traveling direction (in other words, the vehicle 1 may turn left at the intersection CP). As described above, if the vehicle 1 is to travel from the travel path Rd1 to the left road Rd2 at the intersection CP present in the traveling direction, the trajectory generation unit 32 may generate a travel trajectory from the entry position PA toward the exit position PE along the traveling lane boundary Ml11, which is the traveling lane boundary on the left road Rd2 side of the travel path Rd1, without interfering with the intersection center CPc (for example, see a travel trajectory Ob2 in FIG. 4).

The travel control unit 33 causes the vehicle 1 to travel based on the travel trajectory generated by the trajectory generation unit 32. Specifically, the travel control unit 33 may control the steering of the vehicle 1 via the EPS system 40 such that the vehicle 1 travels while tracing the travel trajectory (in other words, the target traveling line) generated by the trajectory generation unit 32. At this time, the travel control unit 33 may control the driving force of the vehicle 1 via the driving force control system 50, or may control the braking force of the vehicle 1 via the braking force control system 60.

### 3. Example of Travel Trajectory Generated by Control Device

Next, a specific example of the travel trajectory generated by the control device 30 using the function of the trajectory generation unit 32 will be described with reference to FIGS. 3 to 6. In the drawings including FIGS. 3 to 6, similarly to the example illustrated in FIG. 2, the vehicle 1 travels on the travel path Rd1 toward the intersection CP, and the intersection CP is present in the traveling direction (that is, in front) of the vehicle 1.

Travel Trajectory Generated when Vehicle is to Turn Right at Intersection

FIG. 3 is a diagram illustrating an example of a travel trajectory generated when the vehicle 1 is to turn right at the intersection CP. In the example illustrated in FIG. 3, the vehicle 1 is about to turn right at the intersection CP and travel to the right road Rd3. In this case, the trajectory generation unit 32 identifies the first reference point Rp1 and the second reference point Rp2 or the intersection center CPc based on the recognition result of the recognition unit 31. Then, the trajectory generation unit 32 derives the first boundary line Bd1 passing through the first reference point Rp1 and the second reference point Rp2 or the intersection center CPc, and generates the travel trajectory Ob1 along the first boundary line Bd1.

As described above, if the vehicle 1 is to turn right at the intersection CP, by deriving the first boundary line Bd1 based on the recognition result of the recognition unit 31 and generating the travel trajectory Ob1 along the first boundary line Bd1, even if no information on the intersection CP is prepared in advance, it is possible to cause the vehicle 1, which is about to travel from the travel path Rd1 to the right road Rd3 at the intersection CP of the four-way intersection obtained by connecting the four roads including the travel path Rd1 and the right road Rd3, to travel based on the appropriate travel trajectory Ob1 without turning too sharply or too gently at the intersection CP.

If the vehicle 1 is to turn right at the intersection CP, the trajectory generation unit 32 generates, for example, a travel trajectory Ob1 including a first trajectory Ob1a that travels straight from the entry position PA to a position in front of the first boundary line Bd1 by a predetermined distance and a second trajectory Ob1b that curves from the end of the first trajectory Ob1a along the first boundary line Bd1. As a result, it is possible to cause the vehicle 1, which is about to travel from the travel path Rd1 to the right road Rd3, to travel based on the same travel trajectory Ob1 as when an occupant of the vehicle 1 drives the vehicle 1.

In the present example, the entry position PA may be, for example, a position at the center in the width direction of the lane Ln11 on the right side (that is, the “R” side illustrated in FIG. 3) of the end closer to the intersection CP of the traveling lane boundary Ml11 of the lane Ln11, which is the host lane. The exit position PE may be, for example, a position at the center in the width direction of the lane Ln31 on the rear side (that is, the “Rr” side illustrated in FIG. 3) of the end closer to the intersection CP of the traveling lane boundary Ml31 of the lane Ln31, which is the destination of right turn.

As described above, if the vehicle 1 is to turn right at the intersection CP, when the right-left-turn method road marking Rm is recognized by the recognition unit 31, the trajectory generation unit 32 may set the intersection center CPc to the location provided with the right-left-turn method road marking Rm, and derive the first boundary line Bd1 passing through the first reference point Rp1 and the intersection center CPc. Alternatively, if the right-left-turn method road marking Rm is not recognized by the recognition unit 31 but the second reference point Rp2 is identified based on the recognition result of the recognition unit 31, the trajectory generation unit 32 may derive the first boundary line Bd1 passing through the first reference point Rp1 and the identified second reference point Rp2. If the second reference point Rp2 is not identified based on the recognition result of the recognition unit 31, the trajectory generation unit 32 may set the intersection center CPc to the location indicated by the node corresponding to the intersection CP in the map information such as the map information database 24, and derive the first boundary line Bd1 passing through the first reference point Rp1 and the intersection center CPc.

Travel Trajectory Generated when Vehicle is to Turn Left at Intersection

FIG. 4 is a diagram illustrating an example of the travel trajectory generated when the vehicle 1 is to turn left at the intersection CP. In the example illustrated in FIG. 4, the vehicle 1 is about to turn left at the intersection CP and travel to the left road Rd2. In this case, the trajectory generation unit 32 generates a travel trajectory Ob2 from the entry position PA toward the exit position PE along the traveling lane boundary Ml11 on the left side of the travel path Rd1 based on the recognition result of the recognition unit 31.

In the present example, the entry position PA may be, for example, a position at the center in the width direction of the lane Ln11 on the right side (that is, the “R” side illustrated in FIG. 4) of the end closer to the intersection CP of the traveling lane boundary Ml11 of the lane Ln11, which is the host lane. The exit position PE may be, for example, a position at the center in the width direction of the lane Ln21 on the rear side (that is, the “Rr” side illustrated in FIG. 4) of the end closer to the intersection CP of the traveling lane boundary Ml21 of the lane Ln21, which is the destination of left turn.

If the vehicle 1 is to turn left at the intersection CP and the vehicle 1 has already entered the intersection CP, the trajectory generation unit 32 may generate the travel trajectory Ob2 from the current position of the vehicle 1 toward the exit position PE (in other words, from the current position of the vehicle 1 toward the entrance of the lane Ln21) based on the recognition result of the recognition unit 31.

As described above, if the vehicle 1 is to turn left at the intersection CP, by generating the travel trajectory Ob2 along the traveling lane boundary Ml11 on the left side of the travel path Rd1 based on the recognition result of the recognition unit 31, even if no information on the intersection CP is prepared in advance, it is possible to cause the vehicle 1, which is about to travel from the travel path Rd1 to the left road Rd2 at the intersection CP of the four-way intersection obtained by connecting the four roads including the travel path Rd1 and the left road Rd2, to travel based on the appropriate travel trajectory Ob2 without turning too sharply or too gently at the intersection CP.

Travel Trajectory Generated when Vehicle is to Travel Straight through Intersection

FIG. 5 is a diagram illustrating an example of the travel trajectory generated when the vehicle 1 is to travel straight through the intersection CP. In the example illustrated in FIG. 5, the vehicle 1 is about to travel from the travel path Rd1 to the opposite road Rd4. In this example, the exit position PE of the vehicle 1 at the intersection CP is offset to the left side (that is, one side in the vehicle width direction) relative to the entry position PA.

In the case illustrated in FIG. 5, the trajectory generation unit 32 identifies the intersection center CPc and generates the travel trajectory Ob3 from the entry position PA toward the exit position PE without interfering with the intersection center CPc. As a result, even if no information on the intersection CP is prepared in advance, it is possible to cause the vehicle 1, which is about to travel from the travel path Rd1 to the opposite road Rd4 at the intersection CP of the four-way intersection obtained by connecting the four roads including the travel path Rd1 and the opposite road Rd4, to travel based on the appropriate travel trajectory Ob3 in consideration of other vehicles traveling at the intersection CP (for example, other vehicles that are about to travel from the opposite road Rd4 to the travel path Rd1).

In the present example, the entry position PA may be, for example, a position at the center in the width direction of the lane Ln11 on the right side (that is, the “R” side illustrated in FIG. 5) of the end closer to the intersection CP of the traveling lane boundary Ml11 of the lane Ln11, which is the host lane. The exit position PE may be, for example, a position at the center in the width direction of the lane Ln41 on the rear side (that is, the “Rr” side illustrated in FIG. 4) of the end closer to the intersection CP of the traveling lane boundary Ml41 of the lane Ln41, which is the destination of straight travel.

More specifically, in the example illustrated in FIG. 5, the trajectory generation unit 32 determines that the exit position PE is offset to the left side relative to the entry position PA based on the recognition result of the recognition unit 31. The trajectory generation unit 32 identifies the first reference point Rp1 and the second reference point Rp2 or the intersection center CPc based on the recognition result of the recognition unit 31 or the like. Then, the trajectory generation unit 32 derives the first boundary line Bd1 passing through the first reference point Rp1 and the second reference point Rp2 or the intersection center CPc.

When the first boundary line Bd1 is derived in this manner, the trajectory generation unit 32 generates the travel trajectory Ob3 passing through a first location P1 that is on the first boundary line Bd1 and is separated from the first reference point Rp1 by a first predetermined distance d11. Here, the first predetermined distance d11 is smaller than a distance d12 from the first reference point Rp1 to the intersection center CPc. Accordingly, it is possible to generate the travel trajectory Ob3 that does not interfere with the intersection center CPc.

The first location P1 may be the inflection point of the travel trajectory Ob3. The travel trajectory Ob3 may have a portion in point symmetry to the first location P1. In this way, as illustrated in FIG. 5, it is possible to generate the travel trajectory Ob3 that is smoothly curved in the intersection CP and is from the entry position PA toward the exit position PE (that is, from the travel path Rd1 toward the opposite road Rd4). Therefore, even if the exit position PE at the intersection CP is offset to the left side relative to the entry position PA, it is possible to cause the vehicle 1, which is about to travel from the travel path Rd1 to the opposite road Rd4, to travel based on the appropriate travel trajectory Ob3 in consideration of other vehicles traveling at the intersection CP.

Further, the travel trajectory Ob3 may be a trajectory away from the fourth reference point Rp4, which is the intersection of the left road Rd2 and the opposite road Rd4, by a predetermined distance. In this way, it is possible to prevent the travel trajectory Ob3 from excessively approaching the fourth reference point Rp4 (in other words, the traveling lane boundary Ml22 of the left road Rd2 or the traveling lane boundary Ml41 of the opposite road Rd4).

FIG. 6 is a diagram illustrating another example of the travel trajectory generated when the vehicle 1 is to travel straight through the intersection CP. In the example illustrated in FIG. 6, the vehicle 1 is about to travel from the travel path Rd1 to the opposite road Rd4. In this example, the exit position PE of the vehicle 1 at the intersection CP is offset to the right side (that is, the other side in the vehicle width direction) relative to the entry position PA. In the following, portions different from the example illustrated in FIG. 5 will be mainly described, and the description of portions common to the example illustrated in FIG. 5 will be appropriately omitted or simplified.

In the case illustrated in FIG. 6, the trajectory generation unit 32 identifies the intersection center CPc and generates the travel trajectory Ob4 from the entry position PA toward the exit position PE without interfering with the intersection center CPc.

More specifically, in the example illustrated in FIG. 6, the trajectory generation unit 32 determines that the exit position PE is offset to the right side relative to the entry position PA based on the recognition result of the recognition unit 31. The trajectory generation unit 32 identifies the third reference point Rp3 and the fourth reference point Rp4 or the intersection center CPc based on the recognition result of the recognition unit 31 or the like. Then, the trajectory generation unit 32 derives the second boundary line Bd2 passing through the third reference point Rp3 and the fourth reference point Rp4 or the intersection center CPc.

When the second boundary line Bd2 is derived in this manner, the trajectory generation unit 32 generates the travel trajectory Ob4 passing through a second location P2 that is on the second boundary line Bd2 and is separated from the third reference point Rp3 by a second predetermined distance d21. Here, the second predetermined distance d21 is larger than a distance d22 from the third reference point Rp3 to the intersection center CPc. Accordingly, it is possible to generate the travel trajectory Ob4 that does not interfere with the intersection center CPc.

The second location P2 may be the inflection point of the travel trajectory Ob4. The travel trajectory Ob2 may have a portion in point symmetry to the second location P2. In this way, as illustrated in FIG. 6, it is possible to generate the travel trajectory Ob4 that is smoothly curved in the intersection CP and is from the entry position PA toward the exit position PE (that is, from the travel path Rd1 toward the opposite road Rd4). Therefore, even if the exit position PE at the intersection CP is offset to the right side relative to the entry position PA, it is possible to cause the vehicle 1, which is about to travel from the travel path Rd1 to the opposite road Rd4, to travel based on the appropriate travel trajectory Ob4 in consideration of other vehicles traveling at the intersection CP.

Further, the travel trajectory Ob4 may be a trajectory away from the fourth reference point Rp4, which is the intersection of the left road Rd2 and the opposite road Rd4, by a predetermined distance. In this way, it is possible to prevent the travel trajectory Ob4 from excessively approaching the fourth reference point Rp4 (in other words, the traveling lane boundary Ml22 of the left road Rd2 or the traveling lane boundary Ml41 of the opposite road Rd4).

### 4. Example of Processing Procedure by Control Device

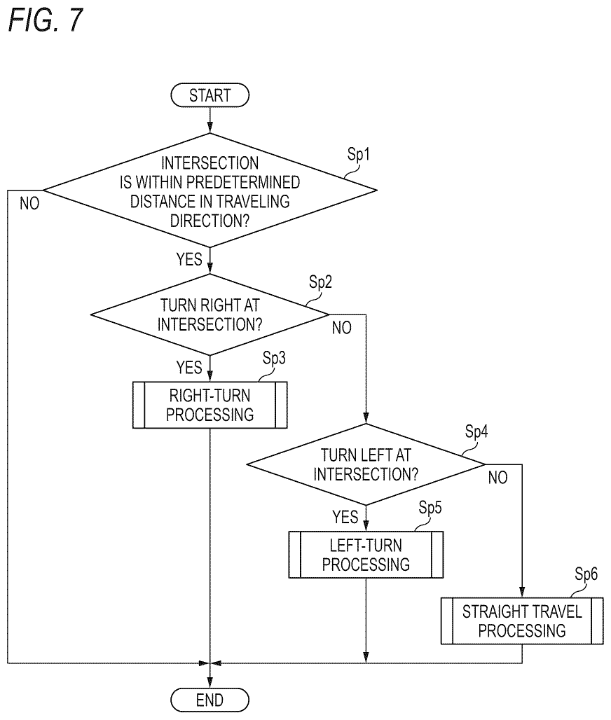

Next, an example of a processing procedure by the control device 30 will be described. FIGS. 7 to 14 are flowcharts (parts 1 to 8) illustrating an example of the processing procedure by the control device 30. For example, when an ignition power supply of the vehicle 1 is turned on, the control device 30 executes a series of processing illustrated in FIGS. 7 to 14 at a predetermined cycle.

As illustrated in FIG. 7, first, the control device 30 determines whether an intersection CP is within a predetermined distance (for example, 30 [m]) in the traveling direction of the vehicle 1 (step Sp1). If it is determined that there is such an intersection CP (step Sp1: YES), the control device 30 determines whether the vehicle 1 is to turn right at the intersection CP (step Sp2). If it is determined that the vehicle 1 is to turn right at the intersection CP (step Sp2: YES), the control device 30 executes right-turn processing described later (step Sp3), and ends the series of processing illustrated in FIGS. 7 to 14.

On the other hand, if it is determined that the vehicle 1 is not to turn right at the intersection CP (step Sp2: NO), the control device 30 determines whether the vehicle 1 is to turn left at the intersection CP (step Sp4). If it is determined that the vehicle 1 is to turn left at the intersection CP (step Sp4: YES), the control device 30 executes left-turn processing described later (step Sp5), and ends the series of processing illustrated in FIGS. 7 to 14.

If it is determined that the vehicle 1 is not to turn left at the intersection CP, that is, the vehicle 1 is to travel straight (step Sp4: NO), the control device 30 executes straight travel processing described later (step Sp6), and ends the series of processing illustrated in FIGS. 7 to 14.

### Right-Turn Processing

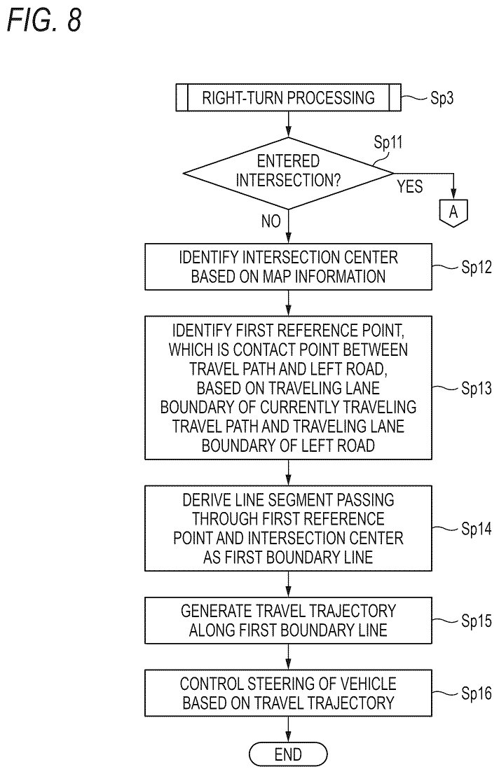

As illustrated in FIG. 8, in the right-turn processing of Sp3, the control device 30 first determines whether the vehicle 1 has entered the intersection CP (step Sp11). If it is determined that the vehicle 1 has not entered the intersection CP (step Sp11: NO), the control device 30 identifies the intersection center CPc based on the map information such as the map information database 24 (step Sp12).

Next, the control device 30 identifies the first reference point Rp1, which is a contact point between the travel path Rd1 and the left road Rd2, based on the traveling lane boundary Ml11 of the travel path Rd1 on which the vehicle 1 currently travels and the traveling lane boundary Ml21 of the left road Rd2 (step Sp13).

Next, the control device 30 derives a line segment passing through the first reference point Rp1 identified by the processing of step Sp13 and the intersection center CPc identified by the processing of step Sp11 as the first boundary line Bd1 (step Sp14).

Next, the control device 30 generates the travel trajectory Ob1 along the first boundary line Bd1 derived by the processing of step Sp14 (step Sp15). Then, the control device 30 controls the steering of the vehicle 1 based on the travel trajectory Ob1 (step Sp16), and ends the current right-turn processing.

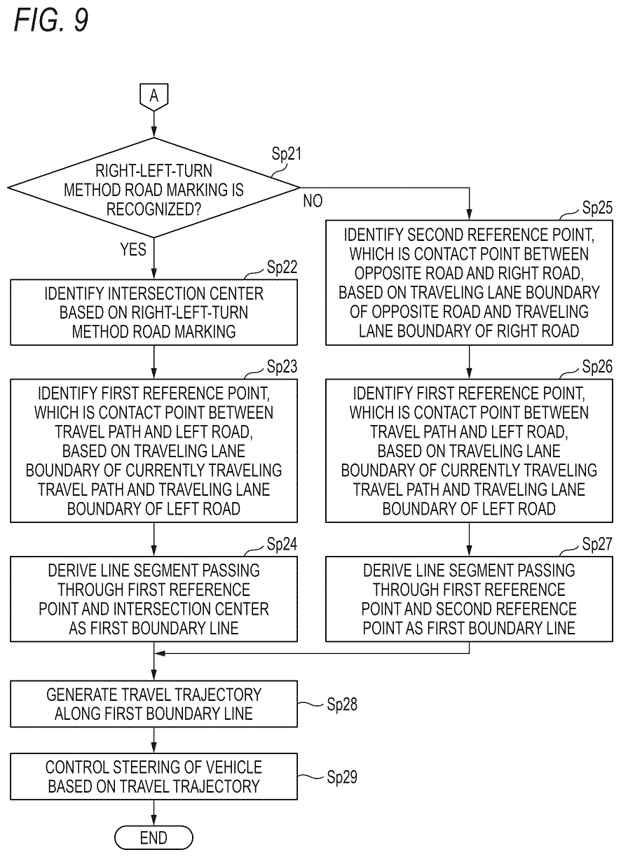

On the other hand, if it is determined in the processing of step Sp11 of FIG. 8 that the vehicle 1 has entered the intersection CP (step Sp11: YES), the control device 30 proceeds to the processing of step Sp21 of FIG. 9, and determines whether the right-left-turn method road marking Rm is recognized (step Sp21).

If it is determined that the right-left-turn method road marking Rm is recognized (step Sp21: YES), the control device 30 identifies the intersection center CPc based on the recognized right-left-turn method road marking Rm (step Sp22).

Next, the control device 30 identifies the first reference point Rp1, which is a contact point between the travel path Rd1 and the left road Rd2 based on the traveling lane boundary Ml11 of the travel path Rd1 on which the vehicle 1 currently travels and the traveling lane boundary Ml21 of the left road Rd2 (step Sp23).

Next, the control device 30 derives a line segment passing through the first reference point Rp1 identified by the processing of step Sp23 and the intersection center CPc identified by the processing of step Sp21 as the first boundary line Bd1 (step Sp24), and proceeds to the processing of step Sp28.

On the other hand, if it is determined in the processing of step Sp21 that the right-left-turn method road marking Rm is not recognized (step Sp21: NO), the control device 30 identifies the second reference point Rp2, which is a contact point between the opposite road Rd4 and the right road Rd3, based on the traveling lane boundary Ml42 of the opposite road Rd4 and the traveling lane boundary Ml31 of the right road Rd3 (step Sp25).

Next, the control device 30 identifies the first reference point Rp1, which is a contact point between the travel path Rd1 and the left road Rd2, based on the traveling lane boundary Ml11 of the travel path Rd1 on which the vehicle 1 currently travels and the traveling lane boundary Ml21 of the left road Rd2 (step Sp26).

Next, the control device 30 derives a line segment passing through the first reference point Rp1 identified by the processing of step Sp26 and the second reference point Rp2 identified by the processing of step Sp25 as the first boundary line Bd1 (step Sp27), and proceeds to the processing of step Sp28.

In the processing of step Sp28, the control device 30 generates the travel trajectory Ob1 along the first boundary line Bd1 derived by the processing of step Sp24 or step Sp27 (step Sp28). Then, the control device 30 controls the steering of the vehicle 1 based on the travel trajectory Ob1 generated by the processing of step Sp28 (step Sp29), and ends the current right-turn processing.

### Left-Turn Processing

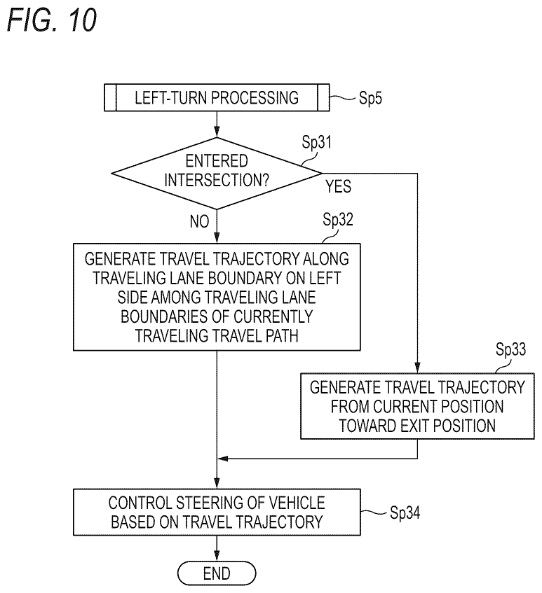

As illustrated in FIG. 10, in the left-turn processing of Sp5, the control device 30 first determines whether the vehicle 1 has entered the intersection CP (step Sp31). If it is determined that the vehicle 1 has not entered the intersection CP (step Sp31: NO), the control device 30 generates the travel trajectory Ob2 along the traveling lane boundary Ml11 on the left side among the traveling lane boundaries Ml11 and Ml12 of the travel path Rd1 on which the vehicle 1 currently travels (step Sp32), and proceeds to the processing of step Sp34.

On the other hand, if it is determined that the vehicle 1 has entered the intersection CP (step Sp31: YES), the control device 30 generates the travel trajectory Ob2 from the current position of the vehicle 1 toward the exit position PE (step Sp33), and proceeds to the processing of step Sp34.

In the processing of step Sp34, the control device 30 controls the steering of the vehicle 1 based on the travel trajectory Ob2 generated by the processing of step Sp32 or step Sp33, and ends the current left-turn processing.

### Straight Travel Processing

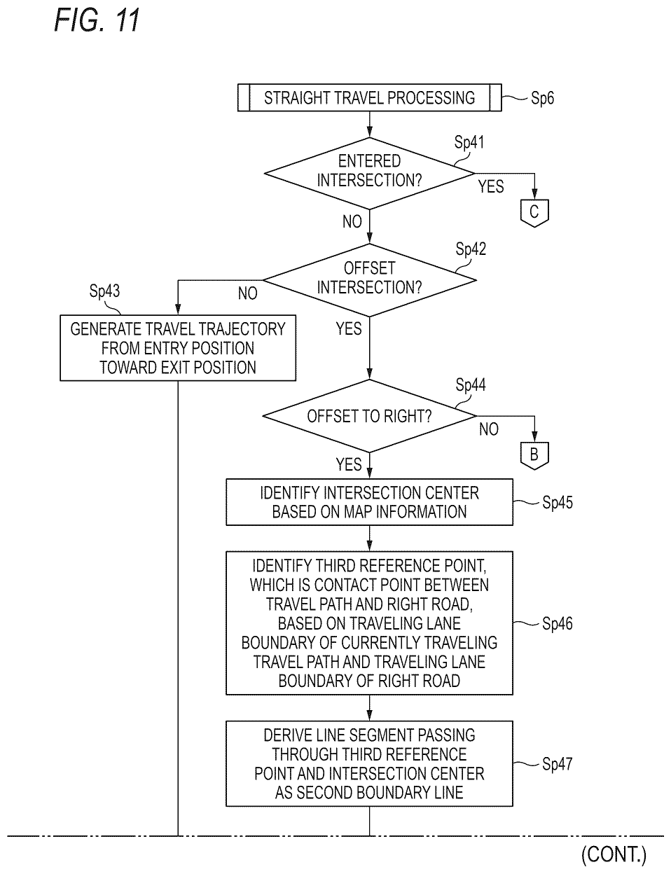

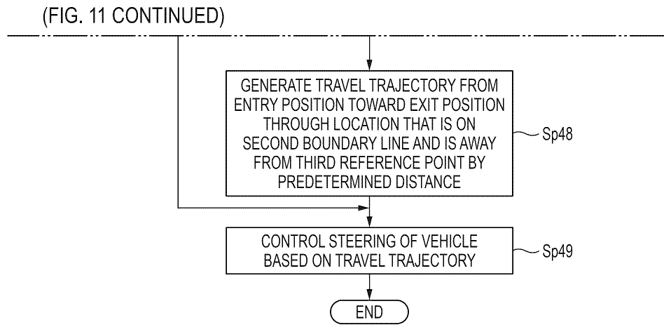

As illustrated in FIG. 11, in the straight travel processing of Sp6, the control device 30 first determines whether the vehicle 1 has entered the intersection CP (step Sp41). If it is determined that the vehicle 1 has not entered the intersection CP (step Sp41: NO), the control device 30 determines whether the intersection CP is an offset intersection, that is, whether the exit position PE of the vehicle 1 at the intersection CP is offset to the left side (in other words, one side in the vehicle width direction) or the right side (in other words, the other side in the vehicle width direction) relative to the entry position PA (step Sp42).

If it is determined that the intersection is not an offset intersection (step Sp42: NO), the control device 30 generates the travel trajectory from the entry position PA toward the exit position PE (step Sp43), and proceeds to the processing of step Sp49. In this case, for example, the control device 30 may generate a travel trajectory that travels straight from the entry position PA toward the exit position PE.

On the other hand, if it is determined that the intersection is an offset intersection (step Sp42: YES), the control device 30 determines whether the exit position PE is offset to the right side relative to the entry position PA as illustrated in FIG. 6 (step Sp44). If it is determined that the exit position PE is offset to the right side relative to the entry position PA (step Sp44: YES), the control device 30 identifies the intersection center CPc based on the map information such as the map information database 24 (step Sp45).

Next, the control device 30 identifies the third reference point Rp3, which is a contact point between the travel path Rd1 and the right road Rd3, based on the traveling lane boundary Ml12 of the travel path Rd1 on which the vehicle 1 currently travels and the traveling lane boundary Ml32 of the right road Rd3 (step Sp46).

Next, the control device 30 derives a line segment passing through the third reference point Rp3 identified by the processing of step Sp46 and the intersection center CPc identified by the processing of step Sp45 as the second boundary line Bd2 (step Sp47).

Next, the control device 30 generates the travel trajectory Ob4 from the entry position PA toward the exit position PE through the second location P2, which is a location that is on the second boundary line Bd2 and is separated from the third reference point Rp3 by the second predetermined distance d21 (see, for example, FIG. 6) (step Sp48), and proceeds to the processing of step Sp49.

In the processing of step Sp49, the control device 30 controls the steering of the vehicle 1 based on the travel trajectory generated by the processing of step Sp43 or step Sp48, and ends the current straight travel processing.

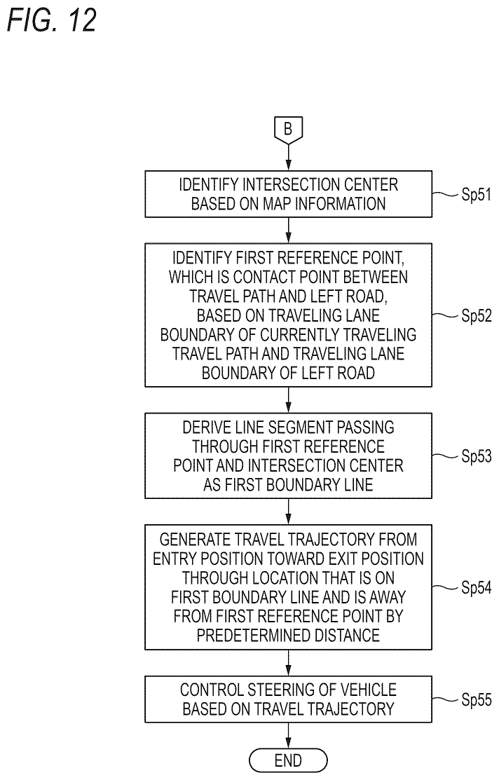

If it is determined in the processing of step Sp44 that the exit position PE is not offset to the right side relative to the entry position PA, that is, if it is determined that the exit position PE is offset to the left side relative to the entry position PA as illustrated in FIG. 5 (step Sp44: NO), the control device 30 proceeds to the processing of step Sp51 in FIG. 12, and identifies the intersection center CPc based on the map information such as the map information database 24 (step Sp51).

Next, the control device 30 identifies the first reference point Rp1, which is a contact point between the travel path Rd1 and the left road Rd3, based on the traveling lane boundary Ml11 of the travel path Rd1 on which the vehicle 1 currently travels and the traveling lane boundary Ml21 of the left road Rd3 (step Sp52).

Next, the control device 30 derives a line segment passing through the first reference point Rp1 identified by the processing of step Sp52 and the intersection center CPc identified by the processing of step Sp51 as the first boundary line Bd1 (step Sp53).

Next, the control device 30 generates the travel trajectory Ob3 from the entry position PA toward the exit position PE through the first location P1, which is a location that is on the first boundary line Bd1 and is separated from the first reference point Rp1 by the first predetermined distance d11 (see, for example, FIG. 5) (step Sp54). Then, the control device 30 controls the steering of the vehicle 1 based on the travel trajectory Ob3 generated by the processing of step Sp54 (step Sp55), and ends the current straight travel processing.

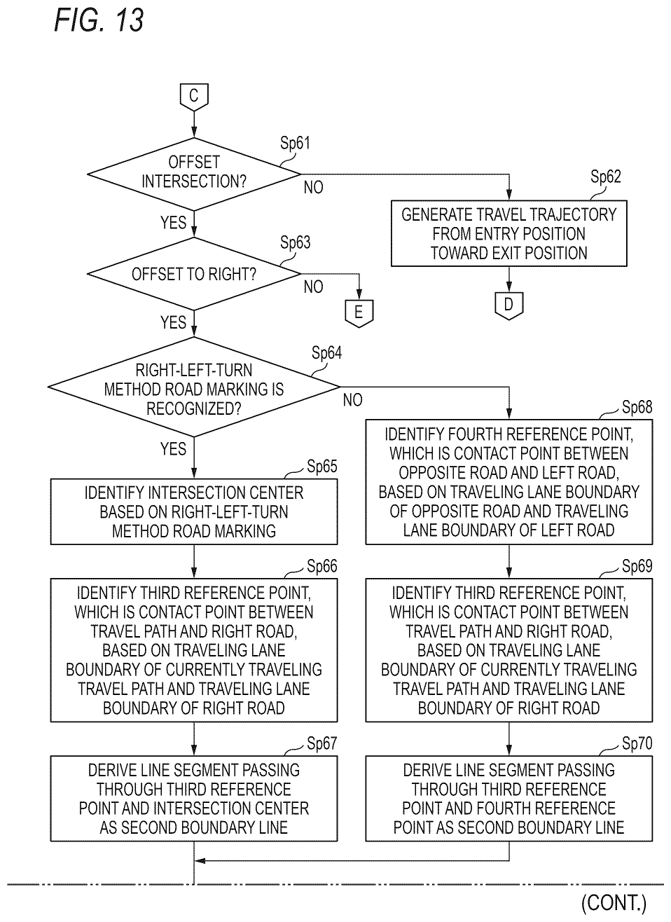

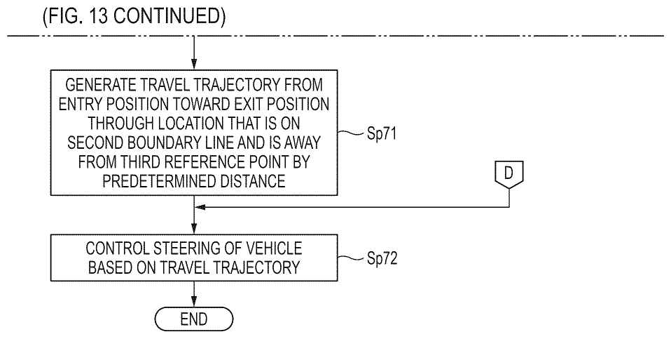

If it is determined in step Sp41 illustrated in FIG. 11 that the vehicle 1 has entered the intersection CP (step Sp41: YES), the control device 30 proceeds to the processing of step Sp61 in FIG. 13 and determines whether the intersection CP is an offset intersection as in the processing of step Sp42 (step Sp61).

If it is determined that the intersection is not an offset intersection (step Sp61: NO), the control device 30 generates the travel trajectory from the entry position PA toward the exit position PE (step Sp62) in the same manner as the processing in step Sp43, and proceeds to the processing in step Sp72.

On the other hand, if it is determined that the intersection CP is an offset intersection (step Sp61: YES), the control device 30 determines whether the exit position PE is offset to the right side relative to the entry position PA (step Sp63), as in the processing of step Sp44.

If it is determined that the exit position PE is offset to the right side relative to the entry position PA (step Sp63: YES), the control device 30 determines whether the right-left-turn method road marking Rm is recognized (step Sp64).

If it is determined that the right-left-turn method road marking Rm is recognized (step Sp64: YES), the control device 30 identifies the intersection center CPc based on the recognized right-left-turn method road marking Rm (step Sp65).

Next, the control device 30 identifies the third reference point Rp3, which is a contact point between the travel path Rd1 and the right road Rd3, based on the traveling lane boundary Ml11 of the travel path Rd1 on which the vehicle 1 currently travels and the traveling lane boundary Ml32 of the right road Rd3 (step Sp66).

Next, the control device 30 derives a line segment passing through the third reference point Rp3 identified by the processing of step Sp66 and the intersection center CPc identified by the processing of step Sp65 as the second boundary line Bd2 (step Sp67), and proceeds to the processing of step Sp71.

On the other hand, if it is determined in the processing of step Sp64 that the right-left-turn method road marking Rm is not recognized (step Sp64: NO), the control device 30 identifies the fourth reference point Rp4, which is a contact point between the opposite road Rd4 and the left road Rd2, based on the traveling lane boundary Ml41 of the opposite road Rd4 and the traveling lane boundary Ml22 of the left road Rd2 (step Sp68).

Next, the control device 30 identifies the third reference point Rp3, which is a contact point between the travel path Rd1 and the right road Rd3, based on the traveling lane boundary Ml12 of the travel path Rd1 on which the vehicle 1 currently travels and the traveling lane boundary Ml32 of the right road Rd3 (step Sp69).

Next, the control device 30 derives a line segment passing through the third reference point Rp3 identified by the processing of step Sp69 and the fourth reference point Rp4 identified by the processing of step Sp68 as the second boundary line Bd2 (step Sp70), and proceeds to the processing of step Sp71.

In the processing of step Sp71, the control device 30 generates the travel trajectory Ob4 from the entry position PA toward the exit position PE through the second location P2, which is a location that is on the second boundary line Bd2 and is separated from the third reference point Rp3 by the second predetermined distance d21 (see, for example, FIG. 6) (step Sp71). Then, the control device 30 controls the steering of the vehicle 1 based on the travel trajectory Ob4 generated by the processing of step Sp71 (step Sp72), and ends the current straight travel processing.

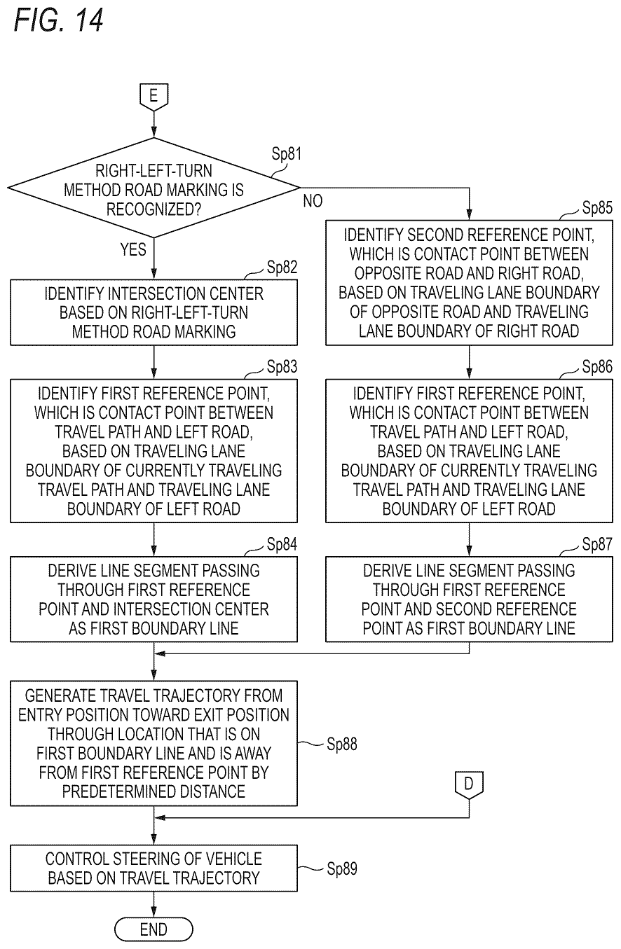

In addition, in the processing of step Sp63 of FIG. 13, if it is determined that the exit position PE is not offset to the right side relative to the entry position PA, that is, if it is determined that the exit position PE is offset to the left side relative to the entry position PA (step Sp63: NO), the control device 30 proceeds to the processing of step Sp81 of FIG. 14, and determines whether the right-left-turn method road marking Rm is recognized.

If it is determined that the right-left-turn method road marking Rm is recognized (step Sp81: YES), the control device 30 identifies the intersection center CPc based on the recognized right-left-turn method road marking Rm (step Sp82).

Next, the control device 30 identifies the first reference point Rp1, which is a contact point between the travel path Rd1 and the left road Rd2, based on the traveling lane boundary Ml11 of the travel path Rd1 on which the vehicle 1 currently travels and the traveling lane boundary Ml21 of the left road Rd2 (step Sp83).

Next, the control device 30 derives a line segment passing through the first reference point Rp1 identified by the processing of step Sp83 and the intersection center CPc identified by the processing of step Sp82 as the first boundary line Bd1 (step Sp84), and proceeds to the processing of step Sp88.

On the other hand, if it is determined that the right-left-turn method road marking Rm is not recognized (step Sp81: NO), the control device 30 identifies the second reference point Rp2, which is a contact point between the opposite road Rd4 and the right road Rd3, based on the traveling lane boundary Ml42 of the opposite road Rd4 and the traveling lane boundary Ml31 of the right road Rd3 (step Sp85).

Next, the control device 30 identifies the first reference point Rp1, which is a contact point between the travel path Rd1 and the left road Rd2, based on the traveling lane boundary Ml11 of the travel path Rd1 on which the vehicle 1 currently travels and the traveling lane boundary Ml21 of the left road Rd2 (step Sp86).

Next, the control device 30 derives a line segment passing through the first reference point Rp1 identified by the processing of step Sp86 and the second reference point Rp2 identified by the processing of step Sp85 as the first boundary line Bd1 (step Sp87), and proceeds to the processing of step Sp88.

In the processing of step Sp88, the control device 30 generates the travel trajectory Ob3 from the entry position PA toward the exit position PE through the first location P1, which is a location that is on the first boundary line Bd1 and is separated from the first reference point Rp1 by the first predetermined distance d11 (see, for example, FIG. 5) (step Sp88). Then, the control device 30 controls the steering of the vehicle 1 based on the travel trajectory Ob3 generated by the processing of step Sp88 (step Sp89), and ends the current straight travel processing.

As described above, according to the control device 30, if the vehicle 1 is to turn right at the intersection CP, it is possible to derive the first boundary line Bd1 based on the recognition result of the recognition unit 31, generate the travel trajectory Ob1 along the derived first boundary line Bd1, and control the steering of the vehicle 1 based on the generated travel trajectory Ob1 (for example, see FIGS. 8 and 9). As a result, even if no information on the intersection CP is prepared in advance, it is possible to cause the vehicle 1, which is about to turn right at the intersection CP, to travel and turn right at the intersection CP based on the appropriate travel trajectory Ob1 without turning too sharply or too gently at the intersection CP.

Further, according to the control device 30, if the vehicle 1 is to turn left at the intersection CP, it is possible to generate the travel trajectory Ob2 along the traveling lane boundary Ml11 of the travel path Rd1 on which the vehicle 1 currently travels or the travel trajectory Ob2 from the current position of the vehicle 1 toward the exit position PE based on the recognition result of the recognition unit 31, and to control the steering of the vehicle 1 based on the generated travel trajectory Ob2 (for example, see FIG. 10). As a result, even if no information on the intersection CP is prepared in advance, it is possible to cause the vehicle 1, which is about to turn left at the intersection CP, to travel and turn left at the intersection CP based on the appropriate travel trajectory Ob2 without turning too sharply or too gently at the intersection CP.

In addition, according to the control device 30, if the vehicle 1 is to travel straight through the intersection CP, it is possible to generate the travel trajectories Ob3 and Ob4 from the entry position PA toward the exit position PE based on the recognition result of the recognition unit 31, and to control the steering of the vehicle 1 based on the generated travel trajectories Ob3 and Ob4. As a result, even if no information on the intersection CP is prepared in advance, it is possible to cause the vehicle 1, which is about to travel straight through the intersection CP, to travel so as to travel straight through the intersection CP based on the appropriate travel trajectories Ob3 and Ob4 in consideration of other vehicles traveling at the intersection CP (for example, other vehicles that are about to travel from the opposite road Rd4 to the travel path Rd1).

Further, according to the control device 30, even if the intersection CP where the vehicle 1 is about to travel straight is an offset intersection as illustrated in FIG. 5 or FIG. 6, it is possible to cause the vehicle 1 to travel straight through the intersection CP based on the appropriate travel trajectories Ob3 and Ob4.

### 5. Modification of Vehicle Control

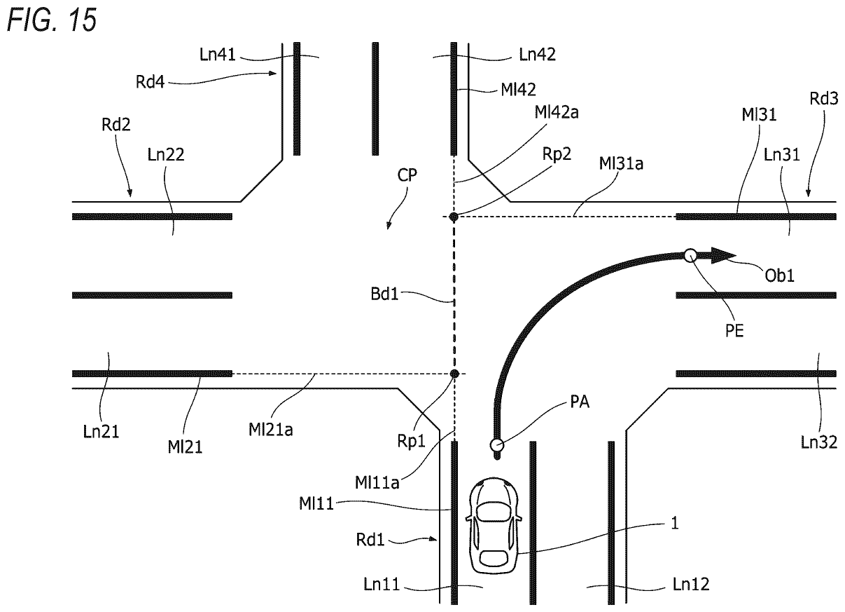

Next, a modification of the vehicle control performed by the control device 30 (for example, the trajectory generation unit 32) will be described. FIG. 15 is a diagram illustrating a modification of vehicle control performed by the control device 30. In the example illustrated in FIG. 15, at the intersection CP, the opposite road Rd4 is greatly shifted to the left side (that is, one side in the vehicle width direction) relative to the travel path Rd1. Therefore, both the first reference point Rp1, which is a contact point between the travel path Rd1 and the left road Rd2, and the second reference point Rp2, which is a contact point between the right road Rd3 and the opposite road Rd4, are present on the left side of the vehicle 1. In the example illustrated in FIG. 15, the vehicle 1 is about to turn right at the intersection CP and travel from the travel path Rd1 to the right road Rd3.

As described above, if the vehicle 1 is to travel from the travel path Rd1 to the right road Rd3 and both the first reference point Rp1 and the second reference point Rp2 are present on the left side (that is, one side in the vehicle width direction) of the vehicle 1, unlike the example illustrated in FIG. 3, the control device 30 may generate the travel trajectory Ob1 from the entry position PA toward the exit position PE without following the first boundary line Bd1. In this way, even if both the first reference point Rp1 and the second reference point Rp2 are present on the left side of the vehicle 1, it is possible to cause the vehicle 1 to travel appropriately so as to travel from the travel path Rd1 to the right road Rd3 at the intersection CP (that is, turn right at the intersection CP).

The control method described in the present embodiment can be implemented by a computer executing a program (control program) prepared in advance. The control program is stored in, for example, a computer-readable storage medium and executed by being read from the storage medium. In addition, the control program may be provided in a form stored in a non-volatile (non-transitory) storage medium such as a flash memory, or may be provided via a network such as the Internet. In the present embodiment, a computer that executes the present control program is a control device 30 (for example, a processor of the control device 30), but is not limited thereto. The computer that executes the control program may be included in the vehicle 1 or may be included in the external device 2 that can communicate with the vehicle 1.

Although an embodiment of the present invention has been described above, it goes without saying that the present invention is not limited to the embodiment. It is apparent that those skilled in the art can conceive of various modifications and alterations within the scope described in the claims, and it is understood that such modifications and alterations naturally fall within the technical scope of the present invention.

In the present specification, at least the following matters are described. Although corresponding constituent elements and the like in the above embodiment are shown in parentheses, the present invention is not limited thereto.

(1) A vehicle control device (control device 30) for controlling a vehicle (vehicle 1), including:

a recognition unit (recognition unit 31) configured to recognize a surrounding situation of the vehicle;

a trajectory generation unit (trajectory generation unit 32) configured to, if an intersection (intersection CP) present in a traveling direction of the vehicle is recognized by the recognition unit, generate a travel trajectory from an entry position (entry position PA) to an exit position (exit position PE) of the vehicle at the intersection; and

a travel control unit (travel control unit 33) configured to cause the vehicle to travel based on the travel trajectory generated by the trajectory generation unit, in which

if the intersection is a four-way intersection obtained by connecting a first road (travel path Rd1) on which the vehicle currently travels, a second road (left road Rd2) present on one side in a vehicle width direction relative to the vehicle, a third road (right road Rd3) present on the other side in the vehicle width direction relative to the vehicle, and a fourth road (opposite road Rd4) present on a side of the intersection opposite to the first road, and the vehicle is to travel from the first road to the third road,

the trajectory generation unit
identifies a first reference point (first reference point Rp1) that is a contact point between the first road and the second road, and a second reference point (second reference point Rp2) that is a contact point between the third road and the fourth road or an intersection center (intersection center CPc) that is a center of the intersection, based on a recognition result of the recognition unit,
derives a first boundary line (first boundary line Bd1) that is a line segment passing through the first reference point and the second reference point or the intersection center, and
generates the travel trajectory (travel trajectory Ob1) along the first boundary line.

According to (1), even if no information on the intersection is prepared in advance, it is possible to cause the vehicle, which is about to travel from the first road to the third road at the intersection of the four-way intersection obtained by connecting the four roads including the first road and the third road, to travel based on an appropriate travel trajectory without turning too sharply or too gently at the intersection. Accordingly, it is possible to provide a vehicle control device that enables a vehicle to appropriately travel in an intersection with a simple configuration. In addition, it is possible to improve traffic safety and contribute to development of a sustainable transportation system.

(2) The vehicle control device according to (1), in which

the vehicle control device is configured to refer to map information (map information database 24) including road network information representing each road by a combination of nodes and a link connecting the nodes, and

the trajectory generation unit
sets a line segment passing through the first reference point and the second reference point as the first boundary line if the second reference point can be identified based on the recognition result of the recognition unit, and
sets a location indicated by a node corresponding to the intersection in the map information as the intersection center and sets a line segment passing through the first reference point and the intersection center as the first boundary line if the second reference point cannot be identified based on the recognition result of the recognition unit.

According to (2), even if the second reference point cannot be identified based on the recognition result of the recognition unit for some reason, it is possible to identify the intersection center based on map information including general road network information and generate an appropriate travel trajectory using the intersection center.

(3) The vehicle control device according to (1) or (2), in which

if the intersection is the four-way intersection and the vehicle is to travel from the first road to the third road, the trajectory generation unit
generates the travel trajectory including a first trajectory (first trajectory Ob1a) that travels straight from the entry position to a position in front of the first boundary line by a predetermined distance and a second trajectory (second trajectory Ob1b) that curves from an end of the first trajectory along the first boundary line.

According to (3), it is possible to cause the vehicle, which is about to travel from the first road to the third road, to travel based on the same travel trajectory as when an occupant of the vehicle drives the vehicle.

(4) The vehicle control device according to any one of (1) to (3), in which

if the intersection is the four-way intersection and the vehicle is to travel from the first road to the fourth road, the trajectory generation unit
generates the travel trajectory (travel trajectories Ob3 and Ob4) from the entry position toward the exit position without interfering with the intersection center.

According to (4), even if no information on the intersection is prepared in advance, it is possible to cause the vehicle, which is about to travel from the first road to the fourth road at the intersection of the four-way intersection obtained by connecting the four roads including the first road and the fourth road, to travel based on an appropriate travel trajectory in consideration of other vehicles traveling at the intersection (for example, other vehicles that are about to travel from the fourth road to the first road).

(5) The vehicle control device according to (4), in which

if the intersection is the four-way intersection and the vehicle is to travel from the first road to the fourth road, the trajectory generation unit determines whether the exit position is offset to the one side or the other side in the vehicle width direction relative to the entry position,

if it is determined that the exit position is offset to the one side, the trajectory generation unit
identifies the intersection center and the first reference point based on the recognition result of the recognition unit,
derives the first boundary line passing through the first reference point and the intersection center, and
generates the travel trajectory passing through a first location (first location P1) that is on the first boundary line and is separated from the first reference point by a first predetermined distance (first predetermined distance d11),

if it is determined that the exit position is offset to the other side, the trajectory generation unit
identifies the intersection center and a third reference point (third reference point Rp3) that is a contact point between the first road and the third road based on a recognition result of the recognition unit,
derives a second boundary line (second boundary line Bd2) that is a line segment passing through the third reference point and the intersection center, and
generates the travel trajectory passing through a second location (second location P2) that is on the second boundary line and is separated from the third reference point by a second predetermined distance (second predetermined distance d21),

the first predetermined distance is smaller than a distance (distance d12) from the first reference point to the intersection center, and

the second predetermined distance is larger than a distance (distance d22) from the third reference point to the intersection center.

According to (5), even if the exit position is an intersection that is offset to the one side or the other side in the vehicle width direction relative to the entry position, it is possible to generate an appropriate travel trajectory that does not interfere with the intersection center. Therefore, it is possible to cause the vehicle, which is about to travel from the first road to the fourth road at such an intersection, to travel based on an appropriate travel trajectory in consideration of other vehicles traveling at the intersection.

(6) The vehicle control device according to (5), in which

the trajectory generation unit
generates the travel trajectory that passes through the first location and has the first location as an inflection point if it is determined that the exit position is offset to the one side (left side), and
generates the travel trajectory that passes through the second location and has the second location as an inflection point if it is determined that the travel trajectory is offset to the other side (right side).

According to (6), it is possible to generate a travel trajectory that is smoothly curved in the intersection and is from the entry position toward the exit position while considering other vehicles traveling in the intersection.

(7) The vehicle control device according to (6), in which

the trajectory generation unit
generates the travel trajectory having a portion in point symmetry to the first location if it is determined that the exit position is offset to the one side, and
generates the travel trajectory having a portion in point symmetry to the second location if it is determined that the travel trajectory is offset to the other side.

According to (7), it is possible to generate a travel trajectory that is smoothly curved in the intersection and is from the entry position toward the exit position while considering other vehicles traveling in the intersection.

(8) The vehicle control device according to any one of (1) to (7), in which

if the vehicle is to travel from the first road to the third road and both the first reference point and the second reference point are present on the one side of the vehicle, the trajectory generation unit generates the travel trajectory from the entry position toward the exit position without following the first boundary line.

According to (8), even if both the first reference point and the second reference point are present on one side of the vehicle, it is possible to cause the vehicle to travel appropriately so as to travel from the first road to the third road at the intersection.

(9) The vehicle control device according to any one of (1) to (8), in which

if the recognition unit recognizes a road marking (right-left-turn method road marking Rm) that designates a portion to pass through when turning right or left at the intersection, the trajectory generation unit sets the intersection center to a location provided with the road marking, and generates the travel trajectory using the intersection center.

According to (9), a location that substantially coincides with the actual center of the intersection can be set as the intersection center, so that it is possible to generate an appropriate travel trajectory.

(10) A control method of a computer (control device 30) for controlling a vehicle (vehicle 1) performing processing including:

recognizing a surrounding situation of the vehicle;

if an intersection (intersection CP) present in a traveling direction of the vehicle is recognized, generating a travel trajectory from an entry position (entry position PA) to an exit position (exit position PE) of the vehicle at the intersection; and

causing the vehicle to travel based on the travel trajectory, in which

the processing of generating the travel trajectory includes:

if the intersection is a four-way intersection obtained by connecting a first road (travel path Rd1) on which the vehicle currently travels, a second road (left road Rd2) present on one side in a vehicle width direction relative to the vehicle, a third road (right road Rd3) present on the other side in the vehicle width direction relative to the vehicle, and a fourth road (opposite road Rd4) present on a side of the intersection opposite to the first road, and the vehicle is to travel from the first road to the third road,
identifying a first reference point (first reference point Rp1) that is a contact point between the first road and the second road, and a second reference point (second reference point Rp2) that is a contact point between the third road and the fourth road or an intersection center (intersection center CPc) that is a center of the intersection, based on a recognition result of the surrounding situation,
deriving a first boundary line (first boundary line Bd1) that is a line segment passing through the first reference point and the second reference point or the intersection center, and
generating the travel trajectory (travel trajectory Ob1) along the first boundary line.

According to (10), even if no information on the intersection is prepared in advance, it is possible to cause the vehicle, which is about to travel from the first road to the third road at the intersection of the four-way intersection obtained by connecting the four roads including the first road and the third road, to travel based on an appropriate travel trajectory without turning too sharply or too gently at the intersection. This enables a vehicle to appropriately travel in an intersection with a simple configuration. In addition, it is possible to improve traffic safety and contribute to development of a sustainable transportation system.

(11) A control program for causing a computer (control device 30) for controlling a vehicle (vehicle 1) to perform processing including:

recognizing a surrounding situation of the vehicle;

if an intersection (intersection CP) present in a traveling direction of the vehicle is recognized, generating a travel trajectory from an entry position (entry position PA) to an exit position (exit position PE) of the vehicle at the intersection; and

causing the vehicle to travel based on the travel trajectory, in which

the processing of generating the travel trajectory includes:

if the intersection is a four-way intersection obtained by connecting a first road (travel path Rd1) on which the vehicle currently travels, a second road (left road Rd2) present on one side in a vehicle width direction relative to the vehicle, a third road (right road Rd3) present on the other side in the vehicle width direction relative to the vehicle, and a fourth road (opposite road Rd4) present on a side of the intersection opposite to the first road, and the vehicle is to travel from the first road to the third road,
identifying a first reference point (first reference point Rp1) that is a contact point between the first road and the second road, and a second reference point (second reference point Rp2) that is a contact point between the third road and the fourth road or an intersection center (intersection center CPc) that is a center of the intersection, based on a recognition result of the surrounding situation,
deriving a first boundary line (first boundary line Bd1) that is a line segment passing through the first reference point and the second reference point or the intersection center, and
generating the travel trajectory (travel trajectory Ob1) along the first boundary line.

According to (11), even if no information on the intersection is prepared in advance, it is possible to cause the vehicle, which is about to travel from the first road to the third road at the intersection of the four-way intersection obtained by connecting the four roads including the first road and the third road, to travel based on an appropriate travel trajectory without turning too sharply or too gently at the intersection. This enables a vehicle to appropriately travel in an intersection with a simple configuration. In addition, it is possible to improve traffic safety and contribute to development of a sustainable transportation system.

### REFERENCE SIGNS LIST

1 vehicle
30 control device (vehicle control device)
31 recognition unit
32 trajectory generation unit
33 travel control unit
Bd1 first boundary line
Bd2 second boundary line
CP intersection
CPc intersection center
d11 first predetermined distance
d21 second predetermined distance
d12 distance
d22 distance
Ob1 travel trajectory Ob1a first trajectory
Ob1b second trajectory
Ob3 travel trajectory
Ob4 travel trajectory
P1 first location
P2 second location
PA entry position
PE exit position
Rd1 travel path (first road)
Rd2 left road (second road)
Rd3 right road (third road)
Rd4 opposite road (fourth road)
Rp1 first reference point
Rp2 second reference point
Rp3 third reference point

What is claimed is:

1. A vehicle control device for controlling a vehicle, comprising:
a recognition unit configured to recognize a surrounding situation of the vehicle;
a trajectory generation unit configured to, in a case where an intersection present in a traveling direction of the vehicle is recognized by the recognition unit, generate a travel trajectory from an entry position to an exit position of the vehicle at the intersection; and
a travel control unit configured to cause the vehicle to travel based on the travel trajectory generated by the trajectory generation unit, wherein in a case where the intersection is a four-way intersection connecting a first road on which the vehicle currently travels, a second road present on one side in a vehicle width direction relative to the vehicle, a third road present on other side in the vehicle width direction relative to the vehicle, and a fourth road present on a side of the intersection opposite to the first road, and the vehicle is to travel from the first road to the third road,
the trajectory generation unit
identifies: a first reference point that is a contact point between the first road and the second road; and a second reference point that is a contact point between the third road and the fourth road or an intersection center that is a center of the intersection, based on a recognition result of the recognition unit,
derives a first boundary line that is a line segment passing through the first reference point and the second reference point or the intersection center, and
generates the travel trajectory along the first boundary line.

2. The vehicle control device according to claim 1, wherein
the vehicle control device is configured to refer to map information including road network information representing each road by a combination of nodes and a link connecting the nodes, and
the trajectory generation unit is configured to
set a line segment passing through the first reference point and the second reference point as the first boundary line in a case where the second reference point can be identified based on the recognition result of the recognition unit, and
set a location indicated by a node corresponding to the intersection in the map information as the intersection center and set a line segment passing through the first reference point and the intersection center as the first boundary line in a case where the second reference point cannot be identified based on the recognition result of the recognition unit.

3. The vehicle control device according to or claim 1, wherein
in a case where the intersection is the four-way intersection and the vehicle is to travel from the first road to the third road, the trajectory generation unit
generates the travel trajectory including a first trajectory that travels straight from the entry position to a position in front of the first boundary line by a predetermined distance and a second trajectory that curves from an end of the first trajectory along the first boundary line.

4. The vehicle control device according to claim 1, wherein
in a case where the intersection is the four-way intersection and the vehicle is to travel from the first road to the fourth road, the trajectory generation unit
generates the travel trajectory from the entry position toward the exit position without interfering with the intersection center.

5. The vehicle control device according to claim 4, wherein
in a case where the intersection is the four-way intersection and the vehicle is to travel from the first road to the fourth road, the trajectory generation unit determines whether the exit position is offset to the one side or the other side in the vehicle width direction relative to the entry position,
in a case where the exit position is determined to be offset to the one side, the trajectory generation unit
identifies the intersection center and the first reference point based on the recognition result of the recognition unit,
derives the first boundary line passing through the first reference point and the intersection center, and
generates the travel trajectory passing through a first location that is on the first boundary line and is separated from the first reference point by a first predetermined distance,
in a case where the exit position is determined to be offset to the other side, the trajectory generation unit
identifies the intersection center and a third reference point that is a contact point between the first road and the third road, based on the recognition result of the recognition unit,
derives a second boundary line that is a line segment passing through the third reference point and the intersection center, and
generates the travel trajectory passing through a second location that is on the second boundary line and is separated from the third reference point by a second predetermined distance,
the first predetermined distance is smaller than a distance from the first reference point to the intersection center, and
the second predetermined distance is larger than a distance from the third reference point to the intersection center.

6. The vehicle control device according to claim 5, wherein
the trajectory generation unit
generates the travel trajectory that passes through the first location and has the first location as an inflection point in a case where the exit position is determined to be offset to the one side, and
generates the travel trajectory that passes through the second location and has the second location as an inflection point in a case where the exit position is determined to be offset to the other side.

7. The vehicle control device according to claim 6, wherein
the trajectory generation unit
generates the travel trajectory having a portion in point symmetry to the first location in a case where the exit position is determined to be offset to the one side, and
generates the travel trajectory having a portion in point symmetry to the second location in a case where the exit position is determined to be offset to the other side.

8. The vehicle control device according to claim 1, wherein
in a case where the vehicle is to travel from the first road to the third road and both of the first reference point and the second reference point are present on the one side of the vehicle, the trajectory generation unit generates the travel trajectory from the entry position toward the exit position without following the first boundary line.

9. The vehicle control device according to claim 2, wherein
in a case where the vehicle is to travel from the first road to the third road and both of the first reference point and the second reference point are present on the one side of the vehicle, the trajectory generation unit generates the travel trajectory from the entry position toward the exit position without following the first boundary line.

10. The vehicle control device according to claim 3, wherein
in a case where the vehicle is to travel from the first road to the third road and both of the first reference point and the second reference point are present on the one side of the vehicle, the trajectory generation unit generates the travel trajectory from the entry position toward the exit position without following the first boundary line.

11. The vehicle control device according to claim 4, wherein
in a case where the vehicle is to travel from the first road to the third road and both of the first reference point and the second reference point are present on the one side of the vehicle, the trajectory generation unit generates the travel trajectory from the entry position toward the exit position without following the first boundary line.

12. The vehicle control device according to claim 5, wherein
in a case where the vehicle is to travel from the first road to the third road and both of the first reference point and the second reference point are present on the one side of the vehicle, the trajectory generation unit generates the travel trajectory from the entry position toward the exit position without following the first boundary line.

13. The vehicle control device according to claim 6, wherein
in a case where the vehicle is to travel from the first road to the third road and both of the first reference point and the second reference point are present on the one side of the vehicle, the trajectory generation unit generates the travel trajectory from the entry position toward the exit position without following the first boundary line.

14. The vehicle control device according to claim 7, wherein
in a case where the vehicle is to travel from the first road to the third road and both of the first reference point and the second reference point are present on the one side of the vehicle, the trajectory generation unit generates the travel trajectory from the entry position toward the exit position without following the first boundary line.

15. The vehicle control device according to claim 1, wherein
in a case where the recognition unit recognizes a road marking that designates a portion to pass through when turning right or left at the intersection, the trajectory generation unit sets the intersection center to a location provided with the road marking, and generates the travel trajectory using the intersection center.

16. The vehicle control device according to claim 2, wherein
in a case where the recognition unit recognizes a road marking that designates a portion to pass through when turning right or left at the intersection, the trajectory generation unit sets the intersection center to a location provided with the road marking, and generates the travel trajectory using the intersection center.

17. The vehicle control device according to claim 3, wherein
in a case where the recognition unit recognizes a road marking that designates a portion to pass through when turning right or left at the intersection, the trajectory generation unit sets the intersection center to a location provided with the road marking, and generates the travel trajectory using the intersection center.

18. The vehicle control device according to claim 4, wherein
in a case where the recognition unit recognizes a road marking that designates a portion to pass through when turning right or left at the intersection, the trajectory generation unit sets the intersection center to a location provided with the road marking, and generates the travel trajectory using the intersection center.

19. A control method of a computer for controlling a vehicle performing processing comprising:
recognizing a surrounding situation of the vehicle;
in a case where an intersection present in a traveling direction of the vehicle is recognized, generating a travel trajectory from an entry position to an exit position of the vehicle at the intersection; and
causing the vehicle to travel based on the travel trajectory, wherein
the generating of the travel trajectory comprises:
in a case where the intersection is a four-way intersection connecting a first road on which the vehicle currently travels, a second road present on one side in a vehicle width direction relative to the vehicle, a third road present on the other side in the vehicle width direction relative to the vehicle, and a fourth road present on a side of the intersection opposite to the first road, and the vehicle is to travel from the first road to the third road,
identifying: a first reference point that is a contact point between the first road and the second road; and a second reference point that is a contact point between the third road and the fourth road or an intersection center that is a center of the intersection, based on a recognition result of the surrounding situation,
deriving a first boundary line that is a line segment passing through the first reference point and the second reference point or the intersection center, and
generating the travel trajectory along the first boundary line.

20. A non-transitory computer readable medium storing a control program for causing a computer for controlling a vehicle to perform processing comprising:
recognizing a surrounding situation of the vehicle;
in a case where an intersection present in a traveling direction of the vehicle is recognized, generating a travel trajectory from an entry position to an exit position of the vehicle at the intersection; and
causing the vehicle to travel based on the travel trajectory, wherein
the generating of the travel trajectory comprises:
in a case where the intersection is a four-way intersection obtained by connecting a first road on which the vehicle currently travels, a second road present on one side in a vehicle width direction relative to the vehicle, a third road present on the other side in the vehicle width direction relative to the vehicle, and a fourth road present on a side of the intersection opposite to the first road, and the vehicle is to travel from the first road to the third road,
identifying: a first reference point that is a contact point between the first road and the second road; and a second reference point that is a contact point between the third road and the fourth road or an intersection center that is a center of the intersection, based on a recognition result of the surrounding situation,
deriving a first boundary line that is a line segment passing through the first reference point and the second reference point or the intersection center, and
generating the travel trajectory along the first boundary line.
